(19) United States
(12) Patent Application Publication
(10) Pub. No.: US 2006/0048988 A1
(43) Pub. Date: Mar. 9, 2006

(54) Device and method for determination of the drive-power distribution in a hybrid driveline of a vehicle

(76) Inventors: Ralf Dreibholz, Meckenbeuren (DE); Johannes Kaltenbach, Friedrichshafen (DE); Friedrich Tenbrock, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/215,626

(22) Filed: Aug. 30, 2005

(30) Foreign Application Priority Data
Sep. 9, 2004 (DE) 102004043589.8

(51) Int. Cl. B62D 61/06

(52) U.S. Cl. 180/213

(57) ABSTRACT

A device and method for determination of the drive-power distribution in a hybrid driveline of a vehicle, a land or water vehicle or an aircraft. The device is characterized by a device for determining a nominal state of charge (soc_ksport) of an energy accumulator as a function of the driver's current, dynamic or economical manner of driving and for determining the current mode of operation (operating mode) of the driveline as a function of the nominal state of charge (soc_ksport), by way of a device (23) for determining the electrically possible nominal drive-power (em_soll_p1) for one electric machine as a function of the nominal state of charge (soc_ksport) and the current mode of operation (operating mode) of the driveline, and by a device for determining the nominal drive-power (vm_soll_p, em_soll_p) for the combustion engine and the at least one electric machine as a function of the electrically possible nominal drive-power (em_soll_p1).

This application claims priority from German Application Serial No. 10 2004 043 589.8 filed Sep. 9, 2004.

### FIELD OF THE INVENTION

The invention concerns a device and a method for the determination of a drive-power distribution in a hybrid driveline of a vehicle, for example a land or water vehicle or an aircraft.

### BACKGROUND OF THE INVENTION

To achieve further reductions of fuel consumption and harmful emissions, in particular from motor vehicles, the automotive industry constantly strives to further the development of hybrid drivelines known in themselves and to create suitable control and regulation equipment for them. In turn, for the operation of such control and regulation equipment, new control and regulation methods are needed which, because of their complexity, are formulated as computer programs and work with the help of associated computers, sensors and actuators.

For example, from GB 2 340 463 A1, a vehicle with a parallel hybrid driveline is known in which the vehicle's drive wheels can be powered optionally by a combustion engine, an electric motor or by both drive machines, simultaneously. A control unit controls and regulates these two drive machines on the basis of sensor information, for example, concerning the speed of the combustion engine, that of the electric motor, the state of charge of an electrical energy accumulator, the speed of the vehicle, the depression of the accelerator pedal which the driver signals his drive-power wish), actuation of the working brakes, the gear-speed selected and the position of a switch which a wish for a very quick vehicle start can be signalled. With the help of this information, for example, the vehicle can be started rapidly under electric power and the electric motor drive can be used to supplement the combustion engine drive for a short-term boost of the vehicle's overall drive-power.

Furthermore, a hybrid-drive vehicle with a control system for controlling the drive-power of the combustion engine and the electric motor is known from EP 0 903 259 B1 in which the control system deduces the drive-power desired by the driver from an accelerator pedal depression signal. The control system then calculates the necessary electric motor drive-power as a function of this accelerator pedal value and the residual electric capacity of an electrical accumulator and then computes a correction magnitude for the power control of the combustion engine so as to reduce its output power until the sum of the electric and combustion engine drive-powers corresponds to the drive-power called for by the depression of the accelerator pedal.

Moreover, various drivelines with associated control and regulation devices are known from EP 1 199 205 A2 which work with control and regulation programs that optimize the hybrid operation of a motor vehicle in relation to the energy flows in is driveline. During this, a purely combustion-powered, a purely electric-powered and a vehicle drive mode with both drive mechanisms are permitted, as also is the operation of at least one electric machine as a generator.

The control and regulation device decides how the current operating condition of the combustion engine and the electric machine of the driveline are to be correlated with the accelerator pedal depression by the vehicle's driver and the speed of the vehicle at the time. This control and regulation device also produces control signals for the combustion engine, the electric machine, a transmission with continuously variable transmission ratio and a clutch between the combustion engine and the electric machine in such manner that the driver's drive-power wishes are fulfilled.

For this purpose, the control and regulation device has a number of optional methods for controlling and regulating the combustion engine, the electric machine and the clutch, and a number of methods for calculating operating points for the combustion engine, the electric machine and the continuously variable transmission. In addition, the control and regulation device comprises control means for controlling the combustion engine, the electric machine, the clutch and the transmission.

It is decisive for the construction and use of this known control and regulation device, that with the help of a so-termed driving condition detector, it determines the current driving condition of the hybrid vehicle, among other things in relation to the accelerator pedal depression, the vehicle's speed and the charge condition (State Of Charge, SOC) of an electric battery and the electrical energy supplied to or drawn from the latter and, on that basis, determines the control and regulation of the combustion engine, the electric machine in its motor and generator operating modes, the actuation of the clutch and the transmission ratio change behavior of the automatic transmission.

Finally, a driveline control system for a motor vehicle with at least two drive aggregates and a transmission is known from WO 02/26520 A1, which the operation of a hybrid vehicle can be improved in relation to fuel consumption, harmful emissions, driving characteristics and drive-power. According to the document, this is achieved with a driveline control system which, first, has decentralized control units for the production of control signals for the drive aggregates and the transmission, as well as a so-termed pedal interpretation device for determining a nominal torque value from a magnitude that characterizes the driver's wish.

In addition, this driveline control system comprises a section known as the nominal status manager where nominal operating status of the driveline at any time is determined as a function of the nominal torque value and from the state of charge of an electrical energy accumulator in the vehicle. Finally, the driveline control system also comprises a section known as the torque manager in where, as a function of the nominal torque value and the determined nominal operating status of the driveline, individual control signals for the decentralized control units mentioned earlier are produced.

In addition, this document also discloses that the driveline control system comprises a section known as the driver and situation recognition section, where detected operating parameters of the vehicle can be evaluated, classified and then transmitted to the nominal status manager for the determination of the nominal operating status. In detail, this driver and situation recognition section can, for example, comprise the following constituent elements: a driver-type recognition system, an environment and road-type localization, and a driving maneuver and driving situation recognition system.

Furthermore, from this state of the prior art, the nominal status manager is known to comprise a configuration recognition system with the aid of which desired operating conditions of the driveline stored in the nominal status manager can be blocked or released depending on the status or value of the configuration recognition system.

A disadvantage of the control device according to WO 02/26520 A1 is that the control and regulation of the at least two drive motors in the combustion-engine, electric-motor and/or generator mode, a clutch and a transmission in the hybrid driveline takes place only on the basis of values that characterize the type of driver and the driving situation at the time. In this, the state of charge of the electrical accumulator at the time is taken as a given magnitude.

However, care must be taken that the charge condition (State Of Charge, SOC), for example, of an electric battery for electric-motor or combined electric-motor and combustion-engine operation, is respectively optimum. How this optimum state of charge is formed; depends on the requirements of the driveline as determined, on the one hand, by a more dynamic and, on the other hand, by a more economical manner of driving. Thus, for a more dynamic driving manner, it is appropriate to have the battery continuously and completely charged as possible so that, with the help of electric-motor support of a combustion-engine drive (boosting), a clearly perceptible power reserve can be used even with a comparatively small and low-power combustion engine or so that the greatest possible range can be achieved in a purely electric-motor operation.

In contrast, for a more orientated and economical manner of driving, it is appropriate to allow the battery to drain to some extent so that, in opportune operating situations of the vehicle, the battery can be replenished by recuperation energy at no cost. For example, the latter is available when the vehicle is freewheeling forwards, while at least one of its electric machines is driven by the drive wheels of the vehicle via the transmission and is working as a generator.

Thus, in a hybrid driveline with more than one drive motor that can be engaged, it must be possible to ensure an optimum distribution between the energy sources and energy sinks in the vehicle's driveline, which also takes appropriate account of the driver's wish for a dynamic vehicle operation mode, an economical one or a mode that lies somewhere between the two.

Accordingly, the purpose of the present invention is to propose a device and method for determination of the drive-power distribution in a hybrid driveline of a vehicle where, compared with the prior art, the power distribution control for the drive aggregates involved in the driveline is effected such that a desired drive-power called for by the vehicle's driver is distributed among the respective drive aggregates in such a manner that a nominal state of charge of an electrical energy accumulator that depends on the driver's driving style and on the operating situation at the time is maintained.

### SUMMARY OF THE INVENTION

The invention concerns a device for determination of the drive-power distribution in a hybrid driveline of a vehicle, for example a land or water vehicle or an aircraft but, in particular a motor vehicle, with a combustion engine, at least one electric drive machine and a transmission. These driveline components also are optionally connected with clutches. In addition, there are ways for detecting the drive-power desired by the driver, ways for detecting the operating parameters of the drive machines, ways for detecting the state of charge of an electrical energy accumulator, and ways for distributing the driver's desired drive-power in the form of nominal power specifications for the at least two drive machines.

The determination device is characterized by:
a device for determining a desired or nominal state of charge of the accumulator as a function of the driver's dynamic or economical driving style at the time, and for determining the current operating status of the driveline as a function of the said nominal state of charge;
a device for determining the electrically possible nominal drive-power for the at least one electric machine as a function of the nominal state of charge and the current operating status of the driveline; and
a device for determining the nominal drive-power for the combustion engine and the at least one electric machine, as a function of the electrically possible nominal drive-power.

The device for determining the drive-power distribution for the drive machines of the hybrid driveline is preferably connected with a control and regulation device for the components of the driveline or is a constituent thereof. On the basis of the drive-power desired by the driver and the drive-power distribution determined, the control and regulation device generates control and regulation signals for the respective drive machines to maintain the drive-power specifications for the at least one clutch by way of which the drive machines can be connected to a transmission input shaft of the transmission and to determine the desired transmission ratio for the transmission unit. For these purposes, the control and regulation device is equipped with electronic fixed-value memories, calculation and comparator modules and is connected via sensor and/or data lines to sensors and actuators.

According to a preferred design of this drive-power distribution determination device, the following magnitudes are also provided and can be fed to the device for determining the nominal state of charge and the operating mode for the calculation of those values, namely, a sportiness characteristic factor, the actual state of charge of the energy accumulator, the drive-power desired by the vehicle's driver and the minimum and maximum power of the combustion engine at its current engine speed.

It can also be appropriate for the minimum and maximum states of charge of the electrical energy accumulator to be communicable to the device for determining the nominal state of charge and the operating mode.

The mentioned sportiness characteristic can preferably be determined by the switch position of a sportiness switch or a transmission selector lever or it can be determined by a measured value that characterizes the acceleration of the accelerator pedal. As is known from the current value of the accelerator pedal's acceleration, it can be determined whether the driver controlling the vehicle at the time prefers a more economical manner of driving reflected in quiet accelerator pedal movements or a more dynamic driving manner reflected in hectic accelerator movements.

The device for determining the electrically, possible nominal power is so constructed for the determination thereof, that the following magnitudes can be fed to it, namely, the current operating mode, the actual state of charge, the nominal state of charge, a characteristic magnitude for limiting the charge and discharge power of the electrical energy accumulator as a function of the sportiness characteristic, the values for the minimum and maximum states of charge of the energy accumulator and the minimum and maximum power of the combustion engine at its current engine speed.

In addition, according to the invention, the determination device is represented by a device for establishing the drive-power distribution which can be fed with the following magnitudes for the determination thereof, namely, the calculated, electrically possible nominal drive-power, the drive-power desired by the driver, the maximum discharge power and the maximum charge power of the energy accumulator and the minimum and maximum drive-power of the at least one electric machine.

It can also be provided that in the device for determining the electrically, possible nominal power for several operating modes that exist in parallel, the respective operating-status-related, electrically, possible nominal drive-power values can be summed at an output of the device to form an electrically possible nominal total drive-power value.

As regards the actual structure of the device 23 for determining the current, electrically possible nominal drive-power, it is preferable to provide a device that has at least one difference calculator 36, in which the difference between the values of the actual and nominal states of charge of the electrical energy accumulator can be computed.

It can also be provided that the device for determining the electrically, possible nominal drive-power has at least one other difference calculator 45, wherein the difference between the actual state of charge and the maximum or minimum state of charge of the electrical energy accumulator can be computed.

It is appropriate for the same device to have, in addition, at least one regulator 37, 371 or 372 with which, from the difference value of the difference calculators 36 or 45, in each case a value for an electric drive-power for the at least one electric machine can be determined.

In addition, it is regarded as advantageous if, to the electric drive-power values determined in the regulator 37, 371, 372, the electric power of other electricity consumers in the motor vehicle can be added (summation calculator 38), so that the electric power uptake of these consumers too can be taken into account when determining the electrically, possible drive-power.

In another design of this device for determining the electrically, possible nominal power, the device has at least one calculation stage 39, 391 or 392 by which the mechanical power of the at least one electric machine can be calculated from the output value of the regulator 37, 371, 372 and knowing the efficiency of the electric machine.

In addition, the device for determining the electrically, possible nominal power comprises at least a filter device 40, which only passes on negative values from the calculation stage 39.

To calculate nominal power specifications for other operating modes, it can be provided that the device for determining the electrically, possible nominal power has at least one other filter device 59, which only passes on positive values from a calculation stage 39 or 392.

Furthermore, the device for determining the electrically, possible nominal power has at least one filter device 42, which only passes on positive values of the drive-power desired by the driver.

Moreover, this device has a filter 44 which only passes on positive values from a difference calculator 47, in which the difference between the drive-power desired by the driver and the maximum possible drive-power of the combustion engine at its current engine speed can be determined.

Furthermore, the device can also provide at least one other filter device 49 which only passes on negative values from that difference calculator 47 in which the difference between the drive-power desired by the driver and the minimum possible combustion engine drive-power at a current engine speed can be determined.

Additionally, it is preferably provided that in the device for determining the electrically, possible nominal power, the output value of the filter device 59, a discharge power limitation value and the output value of the filter device 42 can be fed to a comparator module 41 and this comparator module 41 is configured as a lowest-value calculator that passes on the lowest of the three said values, which indicates the electrically, possible nominal value for the electro-mechanical power for electric-motor drive.

In another variant, in the device for determining the electrically, possible nominal power, it is provided that the output value of the filter device 40, a charge power limitation value and the output value of the second filter device 40 can be fed to a comparator module 43 and this comparator module 43 is configured as a highest-value calculator that passes on the highest of the values, which indicates the electrically possible nominal charging power value when the at least one electric machine is operating as a generator while being driven by the combustion engine.

Corresponding to another variant, in the device for determining the electrically, possible nominal power provides for the output value of the calculation stage 39 and the output value of the filter device 44 being fed to a comparator module 46 and this comparator module 46 is configured as the lowest-value calculator that passes on the lower of the values, which indicates the electrically, possible nominal value for the electric machine's power during electric-motor drive-power boosting of the combustion engine.

To determine the electrically, possible nominal power in another operating mode of the driveline, in the device for determining the electrically, possible nominal power provides for the output value of the calculation stage 39 and an output value of the filter device 49 being fed to a comparator module 48 and this comparator module 48 is configured as the highest-value calculator that passes on the higher of the values, which indicates the electrically, possible nominal, charging power value of the at least one electric machine when the electric machine is operating in a generator mode that has a braking effect on the hybrid vehicle.

A further variant provides that in the device for determining the electrically, possible nominal power, the output value of the calculation stage 391 and the output value of the filter device 49 can be fed to the comparator module 48. The output value of the filter device 40, the value for charge power limitation and the output value of the filter device 49 can be fed to the comparator module 43, and the output values of the two comparator modules 43 and 48 can be fed to a summation module 50, whose output value indicates the electrically, possible nominal, total charging power for generator operation of the at least one electric machine during the recuperation operation and simultaneous generator operation driven by the combustion engine.

Finally, as regards the device for determining the electrically, possible nominal power, it can be provided that the output value of the calculation stage 391 and the output value of the filter device 44 can be fed to a comparator module 51, the output value of the filter device 59, the discharge power limitation value, and the output value of the filter device 42 can be fed to a comparator module 52. The output values of these two comparator modules can be fed to a summation module 53 whose output value indicates the electrically, possible nominal total power for electric-motor operation of the at least one electric machine for the electric motor boosting of the combustion engine using electrical energy from the energy accumulator.

The device for establishing the drive-power distribution 24 is preferably configured such that the operating-mode-related electrically, possible nominal drive-power for generator or motor operation of the at least one electric machine can be fed to a calculation stage 54 for the transformation of the mechanical power specification into an electrical power specification. The output value of this calculation stage can be fed to a first check module 55 for charge and discharge limitation of the energy accumulator. The output of this first check module 55 can be fed to a calculation stage 57 in which the output value of the first check module 55, representing an electric nominal drive-power, can be converted into a mechanical, nominal drive-power for the at least one electric machine and this output magnitude from the calculation stage 57 can be fed to a second check module 56 to take account of the limits of the minimum and maximum power of the at least one electric machine. The output value of the second check module 56 can be fed to an actuator for controlling the at least one electric machine and to a difference calculator 58 in which the difference between the nominal drive-power desired by the driver and the nominal drive-power of the at least one electric machine of the vehicle can be computed and the output value from this difference calculator 58 can be fed to an actuator for the control of the combustion engine's power control element or to a related engine control unit.

The invention also concerns a method for determination of the drive-power distribution in the hybrid driveline, involving the following process steps, namely, the detection of the drive-power desired by the driver; determination of the minimum and maximum power of the combustion engine at its current engine speed; determination of the actual state of charge and of the minimum and maximum states of charge of an energy accumulator; detection of a sportiness characteristic associated with the driver; determination of a minimum and maximum charge power of the energy accumulator, and determination of the minimum and maximum drive-power of the at least one electric machine.

The method is also characterized by a nominal state of charge calculated from the value for the current drive-power desired and the sportiness characteristic. The current operating situation of the vehicle is determined as a function of the sportiness characteristic, the minimum and maximum power of the combustion engine and from the actual state of charge of the energy accumulator, with the help of the values for the sportiness characteristic. The current operating situation, the actual state of charge and the minimum and maximum states of charge of the energy accumulator, a charge power limitation value and a discharge power limitation value, and the minimum and maximum power of the combustion engine at its current engine speed, an electrically, possible nominal drive-power value for the at least one electric machine is determined, and with the help of this electrically possible nominal drive-power value, the minimum and maximum charge power of the energy accumulator and the minimum and maximum drive-power of the at least one electric machine, nominal drive-power values are produced for the at least one electric machine and the combustion engine.

In addition, according to the invention, the method for determining the various operating conditions or modes of operation of the hybrid driveline works as follows. The nominal state of charge of the energy accumulator is determined using the equation:
soc_{—}ksport=SOC_MIN+k_{—}sport*(SOC_MAX−SOC_MIN),
according to which the nominal state of charge soc_ksport is calculated as the sum of the minimum permissible state of charge SOC_MIN of the energy accumulator plus the current sportiness characteristic factor k_sport. The latter assumes only values between the minimum and maximum permissible state of charge SOC_MIN, SOC_MAX of the energy accumulator 28. Additionally, It can be provided that the nominal state of charge soc_ksport is also made dependent on the current driving speed.

According to the method, the “boosting” mode operation is recognized when the following condition is fulfilled:
fahr_{—}soll_{—}p≧vm_max_{—}p&(soc_{—}ist<soc_{—}ksport),
according to which, in relation to its drive-power, the combustion engine is boosted by at least one electric machine when the nominal drive-power fahr_soll_p desired by the driver is greater than or equal to the maximum drive-power vm_max_p that can be provided by the combustion engine at its current engine speed. At the same time, the actual state of charge soc_ist of the energy accumulator is lower than the nominal state of charge soc_ksport determined by the current sportiness characteristic factor k_sport.

The “recuperation” operating mode is recognized by the process when the condition:
fahr_{—}soll_{—}p≦vm_min_{—}p&(soc_{—}ist>soc_{—}ksport),
is fulfilled, in which the nominal drive-power fahr_soll_p is less than or equal to the minimum drive-power vm_min_p that can be provided by the combustion engine at its current speed. At the same time, the actual state of charge soc_ist of the electrical energy accumulator is higher than the nominal state of charge soc_ksport determined by the current sportiness characteristic factor k_sport.

The “fuel charging” operating mode is recognized by the method when the following condition is fulfilled:
(vm_min_{—}p<fahr_{—}soll_{—}p<vm_max_{—}p)&(soc_{—}ist<soc_{—}ksport),
in which the nominal drive-power fahr_soll_p desired by the driver is higher than the minimum drive-power vm_min_p that can be provided by the combustion engine at its current speed and also lower than the maximum drive-power vm_max_p that can be provided by the drive engine at its current speed. At the same time, the actual state of charge soc_ist of the electric energy accumulator is lower than the nominal state of charge soc_ksport determined by the current sportiness characteristic factor k_sport.

The “cap-reserve reduction” operating mode is recognized by the process when the following condition is fulfilled:
(vm_min_{—}p<fahr_{—}soll_{—}p<vm_max_{—}p)&(soc_{—}ist>soc_{—}ksport),
in which the nominal drive-power fahr_soll_p desired by the driver is higher than the minimum drive-power vm_min_p available from the combustion engine at its current speed and lower than the maximum drive-power vm_max_p that can be produced by the drive engine at its current speed. At the same time, the actual state of charge soc_ist of the electrical energy accumulator is higher than the nominal state of charge soc_ksport determined by the current sportiness characteristic factor k_sport.

The “recuperation+fuel charging” operating mode is recognized by the process when the following condition is fulfilled:
(vm_min_{—}p≧fahr_{—}soll_{—}p)&(soc_{—}ist<soc_{—}ksport),
in which the nominal drive-power fahr_soll_p desired by the driver is lower than or equal to the minimum drive-power vm_min_p available from the combustion engine at its current speed. At the same time, the actual state of charge soc_ist of the electrical energy accumulator is lower than the nominal state of charge soc_ksport determined by the current sportiness characteristic factor k_sport.

The “boosting+cap-reserve reduction” operating mode is recognized by the process when the following condition is fulfilled:
(fahr_{—}soll_{—}p≧vm_max_{—}p)&(soc_{—}ist>soc_{—}ksport),
in which the nominal drive-power fahr_soll_p desired by the driver is higher than or equal to the maximum drive-power vm_max_p available from the combustion engine at its current speed. At the same time, the actual state of charge soc_ist of the electrical energy accumulator is higher than the nominal state of charge soc_ksport determined by the current sportiness characteristic factor k_sport.

The “cap-reserve reduction or fuel charging” operating mode is recognized by the process when the following condition is fulfilled:
vm_min_{—}p≦fahr_{—}soll_{—}p≦vm_max_{—}p,
in which the nominal drive-power fahr_soll_p desired by the driver is between the minimum drive-power vm_min_p and the maximum drive-power vm_max_p available from the combustion engine at its current speed, and also the indicated limits can be reached.

The “recuperation+fuel charging” operating mode is recognized when the following condition is fulfilled:
vm_min_p>fahr_soll_p,
in which the nominal drive-power fahr_soll_p desired by the driver need only be lower than the minimum drive-power vm_min_p available from the combustion engine VM at its current engine speed.

Finally, the “boosting+cap-reserve reduction” operating mode is recognized by the process when the following condition is fulfilled:
fahr_soll_p>vm_max_p,
in which the nominal drive-power fahr_soll_p desired by the driver need only be higher than the maximum drive-power vm_max_p available from the combustion engine at its current speed.

### BRIEF DESCRIPTION OF THE DRAWINGS

The invention will now be described, by way of example, with reference to the accompanying drawings. In doing this, the features of the device and those of the method are explained conjointly. Taken individually, the Figures show:

FIG. 1 is a schematic representation of a parallel-hybrid driveline with a combustion engine and one electric drive machine;

FIG. 2 is a driveline as in FIG. 1, but with two electric drive machines;

FIG. 3 is a system model of the driveline in FIG. 1;

FIG. 4 is a system model of the driveline in FIG. 2;

FIG. 5 is a functional structure of the device and method for determination of the drive-power distribution for the drive machines of the drivelines in FIG. 1 or FIG. 2;

FIG. 6 is a functional structure of a device for determining the nominal state of charge of the energy accumulator and the operating mode;

FIG. 7 is a functional structure for determining the nominal state of charge of the energy accumulator;

FIG. 8 is a table listing the conditions for particular operating modes of the driveline;

FIG. 9 is another table as in FIG. 8;

FIG. 10 is a functional structure for determining an electrically possible nominal total drive-power in which individual components are summed;

FIG. 11 is a functional structure for determining an electrically possible nominal drive-power with commutation between individual components;

FIG. 12 is a functional structure similar to FIG. 11;

FIG. 13 is a functional structure of the device and method for determining an electrically, possible nominal drive-power em_capres_p;

FIG. 14 is a functional structure according to FIG. 13 for determining an electrically possible nominal drive-power em_kraftlad_p;

FIG. 15 is a functional structure as in FIG. 13 for determining an electrically, possible nominal power em_boost_p;

FIG. 16 is a functional structure according to FIG. 13 for determining an electrically, possible nominal charge power em_rekup_p;

FIG. 17 is a functional structure for determining an electrically, possible nominal total drive-power em_soll_sum_p_gen at which the at least one electric machine is to work most precisely;

FIG. 18 is another functional structure as in FIG. 17 for determining an electrically, possible nominal total drive-power em_soll_sum_p_mot at which the at least one electric machine is to operate as a motor; and

FIG. 19 is a functional structure of the device and method for determining the drive-power distribution for the drive machines from the electrically, possible nominal drive-power em_soll_sum_p, which represents the sum of all the individual components.

### DETAILED DESCRIPTION OF THE INVENTION

The device and method, according to the invention, can be advantageously used with parallel-hybrid drivelines for motor vehicles configured in various ways.

The invention concerns such configurations of an arbitrary parallel-hybrid driveline wherein a the combustion engine VM and at least one electric machine EM1 and EM2 act cooperatively on the vehicle's drive via an arbitrary type of transmission. The simplest version is a driveline with a starter-generator which is kinematically coupled to the combustion engine via a fixed gear ratio. For advantageous use of the invention, it is not necessary that the combustion engine and/or the at least one electric machine should be able to be disengaged from the vehicle's driveline by at least one clutch. The powers of the at least two drive aggregates can be summed directly on the same drive shaft or by way of a superposing transmission (for example, a planetary transmission).

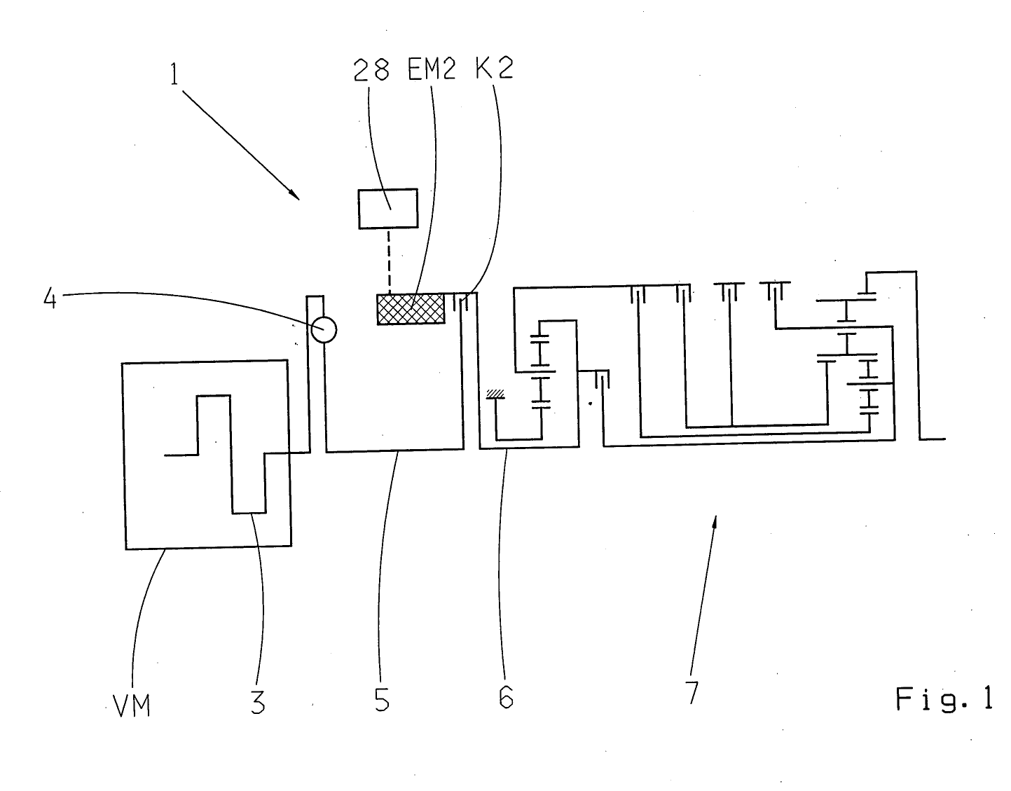

As an example, FIG. 1 shows such a driveline 1 comprising a combustion engine VM, one electric machine EM and an automatic transmission 7, the latter being in the form of the 6HP26 variable-speed, automatic transmission included in the production range of the present Applicant and thus known as such. Accordingly, nothing further need be said about its structure. In essence any type of transmission, such as a manual-shift transmission or automatic-gearshift or continuously variable transmissions, can be used.

In this example embodiment, a torque produced by the combustion engine VM is transmitted, via its crankshaft 3, to a rotation fluctuation damper 4, which, in a known way, damps the rotation non-uniformities produced during operation of the combustion engine VM and then passes on the drive-power, via its output element 5. On the output side of the rotation fluctuation damper 4, an actuator-operable clutch K2 is drive-technologically disposed, whose output side is in rotary connection with the drive shaft of an electric machine EM2 and with an input shaft 6 of the automatic transmission 7. Such a parallel-hybrid driveline is known in its own right and its mode of operation will, therefore, be described only briefly below.

In pure combustion-engine operation, a crankshaft 3 of the combustion engine VM drives the transmission input shaft 6 when a clutch K2 is engaged. During vehicle operation, various gear ratios are engaged in the automatic transmission 7 by a control unit 20, these enabling various drive-powers and drive input speeds to be realized at the transmission output shaft.

In pure electric-motor operation, the clutch K2 is disengaged and the electric machine EM2, drawing power from an electrical energy accumulator 28 and controlled by a control unit 12, drives the transmission input shaft 6 with a desired drive-power. In this mode of operation too, the transmission 7 operates as described above.

In a third mode of operation, the combustion engine VM and the electric machine EM2 drive the transmission shaft 6 conjointly when the clutch K2 is engaged so that, for example, even a vehicle with a comparatively low-power and low-consumption combustion engine VM can be operated in certain operating situations with a considerably higher drive torque.

In a fourth operating mode, when the vehicle is freewheeling with the clutch K2 disengaged, the combustion engine VM is switched off so that the electric machine EM2 is driven by the vehicle's drive wheels via the transmission 7. In this operating mode, the electric machine EM2 works as a generator so that the electrical energy produced is advantageously led into the energy accumulator 28.

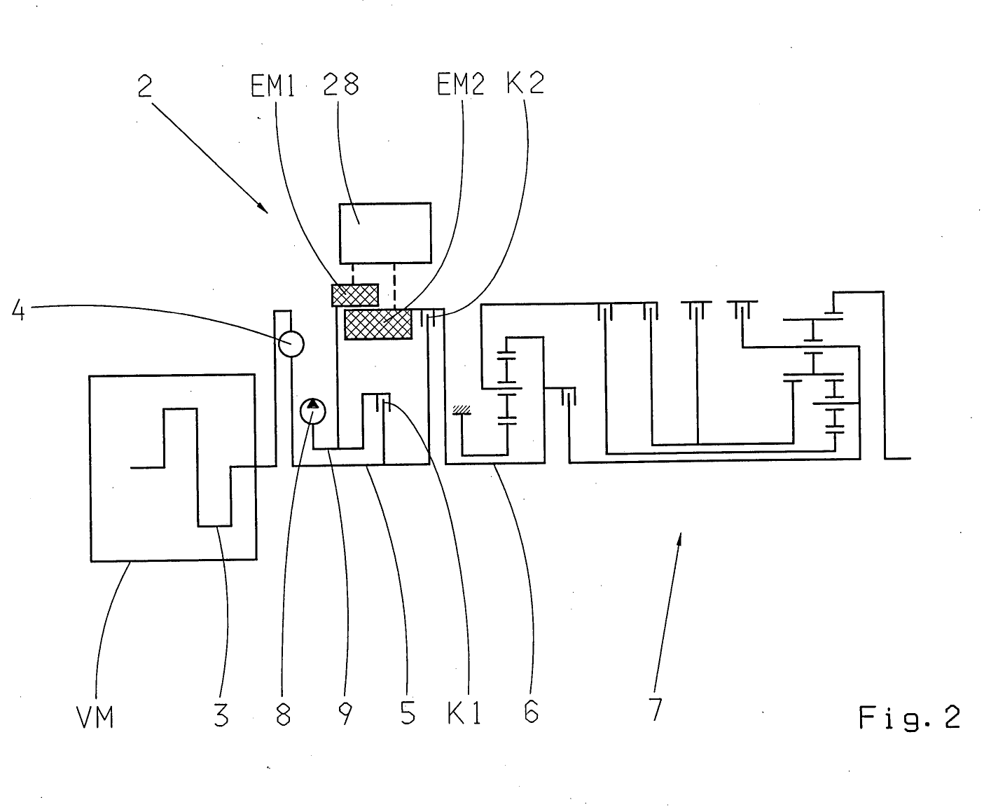

FIG. 2 shows a parallel-hybrid driveline 2 for a motor vehicle with a structure similar to that of the driveline shown in FIG. 1. The difference is that a further electric machine EM1 is present, which can also be supplied with electrical energy from the accumulator 28. In this driveline 2, the electric machine EM1, a starter-generator works either as an electric motor or as a generator, just as the electric machine EM2 can work as an electric motor or as a generator. In addition, the electric machine EM1 can, if necessary, drive the drive shaft 9 of an oil pump 8 by way of which, among other things, the hydraulic pressure needed in the driveline 2 for the pressure-medium-operated actuators fitted therein can be produced.

With this second driveline 2 is also associated another clutch K1, whose input component is in driven connection with an output 5 of the rotation fluctuation damper 4. The output of this clutch K1 is in rotary connection with the drive shaft 9 of the oil pump 8 and the drive shaft of the electric machine EM1.

In contrast to the operating mode of the driveline 1 in FIG. 1 with the driveline 2 of FIG. 2, the oil pump 8 can be driven by the electric machine EM1 independently of the operation of the combustion engine VM and any driving movement of the vehicle. This is advantageous above all because, for a quick start of the vehicle, for example, after a longer pause in operation, the hydraulic pressure necessary for operating the actuators for the clutches K1 and K2 and the actuators of the transmission 7 does not have to be built up only after the combustion engine VM has been started and is operating.

In addition this driveline 2, in which the electric machine EM1 is preferably designed with a lower power than the electric machine EM2, allows the oil pump 8 to be driven even in operating phases of the vehicle in which the combustion engine VM is switched off and disengaged from the driveline 2, and the electric machine EM2 is working as a generator and feeding electric current into the energy accumulator 28.

Furthermore, both electric machines EM1 and EM2 can be made as starter-generators so that when the clutches K1 and K2 are engaged, the electrical energy accumulator 28 can be charged by both electric machines at once in a rapid-charge phase under combustion-engine drive.

Finally, in a further operating mode, it is possible for the combustion engine VM and both electric machines EM1 and EM2 to allow a conjoint torque to be produced when the clutches K1 and K2 are engaged, which acts upon the transmission input shaft 6 and, in a last operating mode, the electric machine EM1 can be used as a starter motor for the combustion engine VM when the clutch K1 is engaged and the clutch K2 is disengaged.

The invention now concerns the optimum distribution of the drive-power fahr_soll_p desired by the driver between the combustion engine VM and the at least one electric machine EM1 or EM2 of the driveline in such a manner that, on the one hand, the drive-power called for by the driver is effective at the drive wheels of the vehicle. This drive-power is produced by conjoint action of the drive motors VM, EM1 or EM2 in such a manner that the vehicle is operated with low emissions, saving of fuel and in the operating mode (more dynamic or more economical) desired by the driver at the time.

To explain the invention further, system models of the drivelines 1 and 2, described above, are explained below which represent, in simplified form, the cooperation of the driveline components with control devices assigned thereto.

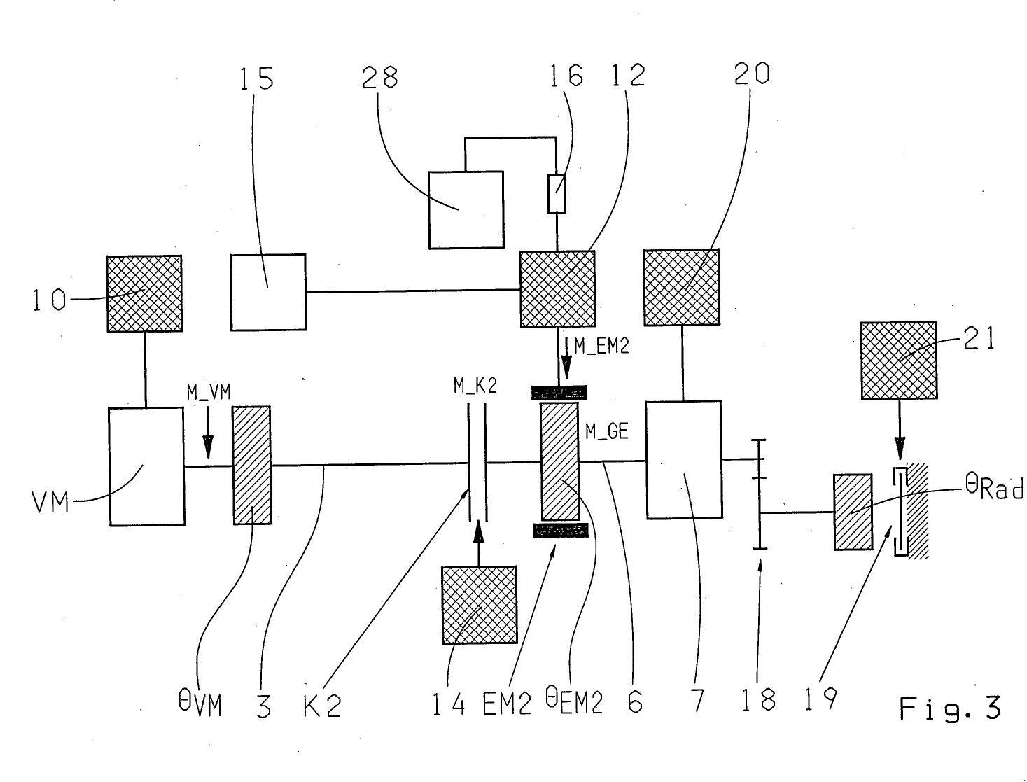

Thus, FIG. 3 shows such a system model for the driveline 1 represented in FIG. 1. Here too the main components of the hybrid driveline are shown, including the combustion engine VM with its moment of inertia ΘVM, the clutch K2, the electric machine EM2 with its moment of inertia ΘEM2, the transmission 7, a differential 18 and the vehicle's drive wheels, symbolized by their moment of inertia ΘRad (Θwheel).

As this representation makes clear, the combustion engine VM produces a drive torque M_VM, which is transmitted as a clutch torque M_K2 to the input side of the electric machine EM2 when the clutch K2 is engaged. If it is not just idling but acting as an electric motor, the electric machine EM2 produces a drive torque M_EM2 which, together with the drive torque M_VM of the combustion engine VM, forms a drive torque M_GE at the transmission input shaft 6. After ratio-related transformation in the transmission 7 and in the differential 18, the desired drive torque is delivered to the drive wheels of the vehicle.

As FIG. 3 also makes clear, the operating mode of the combustion engine VM is controlled and regulated by a control unit 10, that of the clutch K2 by a control unit 14, that of the electric machine EM2 by a control unit 12, and that of the transmission 7 by a control unit 20. In addition, an actuator-operated braking device 19, for example in the form of the vehicle's working brakes, can be provided at the vehicle's wheels and controlled by a control unit 21.

It can also be seen that the electric machine EM2 is connected (for example, by the control unit 12) to an electric power supply 15 of the vehicle and, via unavoidable line resistances 16, 17, to the electrical energy accumulator 28 from which the electric machine EM2 can draw and into which it can pass electric current.

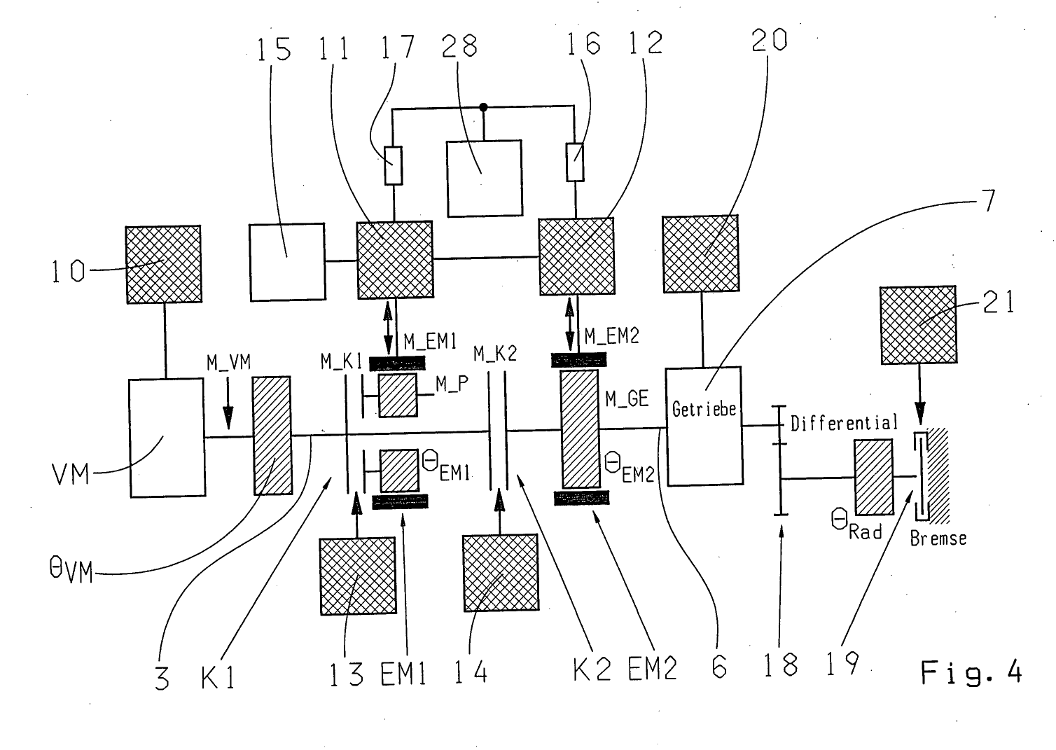

As shown in FIG. 4, the main difference between the system model for the driveline 2 shown in FIG. 2 and the system model according to FIG. 3 explained above, is that control units 11 or 13 are also provided, respectively, for the additional clutch K1 and the other electric machine EM1. It can also be seen that the electric machine EM1 has a moment of inertia ΘEM1, which is incorporated by summation in the overall driveline when the clutch K1 is engaged. At this point, it should be obviously mentioned that the two clutches K1 and K2, the rotation fluctuation damper 4 and other driveline components such as the associated drive shafts, in each case, have a moment of inertia which, however, for the sake of simplicity, are taken to be included in the moments of inertia already mentioned.

In particular, the two FIGS. 3 and 4 make it clear that the control and regulation provision for such hybrid drivelines is comparably large. This applies particularly when control and regulation of the driveline components, orientated towards the drive-power called for by the driver or the related automatic drive torque specification device, such as a speed regulation device or a distance regulation device, should take place, which also enables an operating mode of the vehicle that saves fuel and produces low emissions.

Thus, the invention proposes a determination device for determining the drive-power distribution and a method for operating such a device, which achieves the stated objectives and takes the mentioned boundary conditions into account. This determination device is part of a control and regulation device of the hybrid vehicle or works closely with it. The control and regulation device is preferably realized in a single computer with individual memories, input and output zones, calculation modules and comparator modules, such that the necessary sensor information is passed to the computer as measurement values from individual sensors or vehicle components and commands for the operation of actuators are emitted from it.

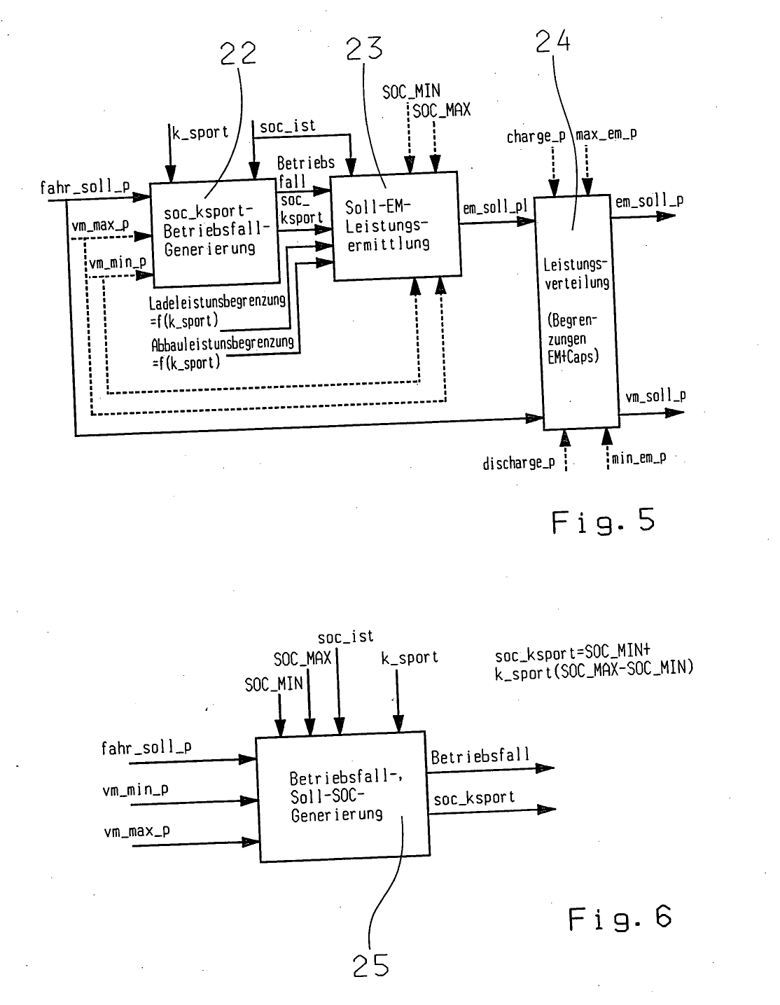

According to FIG. 5, the determination device with the characteristics of the invention has three interlinked determination means 22, 23 and 24, with the help of which measurement values concerning the current operating situation of the driveline, vehicle-specific fixed values or constants and the current drive-power desired by the driver, and a parameter characterizing his driving style, can be processed in such a manner that the desired drive-power is transformed into drive torque or drive-power specifications for the at least two drive machines of the vehicle such that, on the one hand, the drive-power wish is fulfilled and, on the other hand, an optimum charge specification adapted to the current driving situation and state of charge of the electrical energy accumulator 28 can be realized for the accumulator 28.

Accordingly, in contrast to the known technical solutions in this case, the current driver's wish concerning the vehicle's drive torque and the vehicle's manner of operation actually desired, namely, one that is more dynamic or more economical, are taken into account in the control and regulation of the driveline components. In addition, the state of charge of the vehicle's electrical energy accumulator 28 and its discharging and charging are made dependent on the above-mentioned boundary conditions. In this way, the respective optimum state of charge of the energy accumulator 28 is achieved for any manner of operation, whether dynamic or economical.

In detail, FIG. 5 shows that the first determination means 22 consists of a device for determining a nominal state of charge soc_ksport of the energy accumulator 28 and a characteristic magnitude denoted as the operating mode for determination of the current operating mode or current manner of operating the vehicle. These two magnitudes, soc_ksport and operating mode, are determined as a function of a current drive-power fahr_soll_p desired by the driver, a minimum and a maximum drive-power vm_min_p or vm_max_p of the combustion engine VM at the engine speed existing at the time, an actual state of charge soc_ist of the electrical energy accumulator 28, and a sportiness characteristic factor k_sport, the latter characterizing the driver's manner of driving in terms of whether it is more dynamic and sporty or more defensive and economical.

As is known, the drive-power fahr_soll_p desired by the driver can be determined from the depression angle of the accelerator pedal, while the sportiness characteristic factor k_sport can be determined, for example, from the acceleration of the accelerator pedal and/or from the position of a related switch. The values for the minimum and maximum drive-power vm_min_p or vm_max_p of the combustion engine VM can be read out from a stored table of values as a function of the current engine speed.

The determination means 22 are preferably configured such that, from the sportiness characteristic factor k_sport, the actual state of charge soc_ist and the desired drive-power fahr_soll_p, the nominal state of charge soc_ksport can be determined as an output magnitude. According to a further configuration of these determination means 22, with the help of the nominal state of charge soc_ksport, the desired drive-power fahr_soll_p and the above-mentioned drive-power specifications for the minimum and maximum drive-powers vm_min_p or vm_max_p of the combustion engine VM, the current operating mode can be determined and provided as a further output magnitude for the device 23 for determining the nominal power of the at least one electric machine EM1, EM2.

Among the operating modes to be determined, for example the following driving conditions can be distinguished:
a) The combustion engine VM is unable on its own to provide the drive torque called for as the nominal drive-power fahr_soll_p desired by the driver. In this case, at least one of the electric machines EM1, EM2 has to be coupled into the driveline 1, 2 and operated as an electric motor. When this is done in the “boost” driving mode, a larger drive-power is available than could be provided by the combustion engine alone. For electric-motor operation, however, electrical energy is needed and this is drawn from the electrical energy accumulator 28.
b) A combustion engine operating mode is also possible, in which the combustion engine VM is coupled into the driveline 1, 2 and acts in a thrust-operation phase without fuel supply, but only with a braking effect on the vehicle or is decoupled from the driveline. When at least one electric machine EM1, EM2 is coupled, this can be operated to work in generator mode, so that this at least one electric machine too brakes the vehicle and passes electrical energy EM1, EM2 into the energy accumulator 28.
c) In other driving situations, during which the combustion engine VM would on its own be able to provide the drive-power fahr_soll_p currently called for by the driver, it must be decided whether the electrical energy accumulator 28 should be charged with electrical energy by operating the at least one electric machine EM1, EM2 in generator mode by the use of fuel (i.e., during combustion engine operation) or whether by operating this at least one drive machine EM1, EM2 as a motor. The state of charge soc_ist of the energy accumulator 28 should be reduced.
d) Finally, the hybrid vehicle can also be operated in pure electric-motor mode, if this is called for, for example, by the position of a separate switch or perhaps by a sensor in the fuel tank.

The device 23 for determining the nominal power of the at least one electric machine EM1, EM2 is configured such that it has an input zone to which the following magnitudes can be fed: the operating mode determined by the determination means 22; the nominal state of charge soc_ksport of the energy accumulator 28 deemed necessary; the actual state of charge soc_ist of the accumulator; the minimum and maximum possible storage capacities SOC_MIN or SOC_MAX of the accumulator; the values of the minimum and maximum drive-power vm_min_p or vm_max_p of the combustion engine VM, and a charge power limitation characteristic (charging power limitation) and discharge power limitation characteristic (discharging power limitation) for the charging and discharging of the electrical energy accumulator 28.

Let it be said here that the last-mentioned limits denoted as charge power limitation and discharge power limitation, as regards their value, can be read from related tables as a function of the current sportiness characteristic factor k_sport, these tables preferably being stored in the control and regulation device for the hybrid drive.

In contrast to known control and regulation devices for hybrid drivelines, the task of the device 23 is, among others, to limit an electrically possible electric-motor power em_soll_p1 in such manner that the optimum nominal state of charge soc_ksport of the electrical energy accumulator 28 is maintained. Here too, the power limits of the at least one electric machine EM1, EM2 are taken into account (see also FIG. 19).

This value for the nominal drive-power of the at least one electric machine EM1, EM2 can be sent from the output of the device 23 to the device 24 that determines the drive-power distribution. In addition, the input zone of the device 24 is suitably configured for receiving and passing on the following further magnitudes: the drive-power fahr_soll_p desired by the driver, a maximum discharge power discharge_p and a maximum charge power charge_p of the energy accumulator 28, and a minimum and maximum drive-powers, min_em_p and max_em_p, respectively, of the at least one electric machine EM1, EM2.

For establishing the drive-power distribution, the device 24 is also configured such that it produces a respective nominal drive-power values em_soll_p for the at least one electric machine EM1, EM2 and a nominal drive-power value vm_soll_p for the combustion engine VM, and passes them on to those drive machines EM1, EM2, VM or to other control modules of the control and regulation device of the hybrid vehicle.

FIG. 6 shows a variant of the device 22 (shown in FIG. 5) for determining the nominal state of charge soc_ksport for the energy accumulator 28 and the current operating mode. Although a device 25, shown in this Figure, performs the same function as the device 22, in contrast to the latter, however, this one is configured such that the values for the minimum and maximum charge capacities SOC_MIN and SOC_MAX of the electrical energy accumulator 28 can also be communicated to it.

Below, the magnitudes emitted by the devices 22 or 25 for the optimum state of charge soc_ksport of the energy accumulator 28 and the operating mode determined will be explained further.

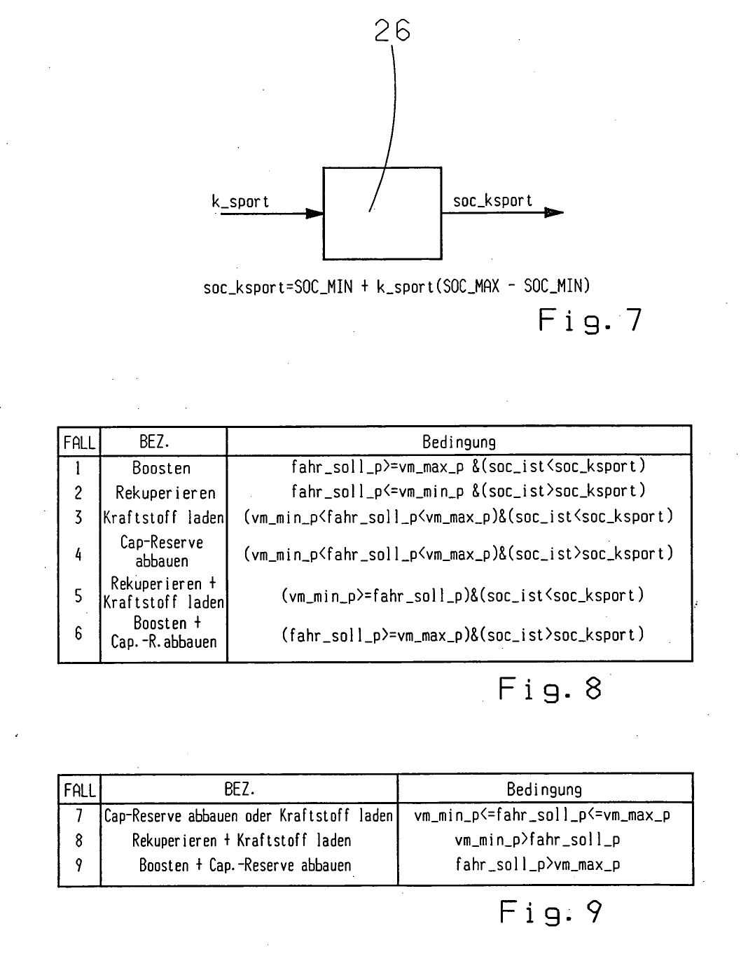

As FIG. 7 makes clear, the optimum nominal state of charge soc_ksport of the energy accumulator 28 is determined in the devices 22, 25 directly from the sportiness characteristic factor k_sport, for which purpose a separate calculation module 26 can be provided therein. Here, the applicable boundary condition is:
soc_{—}ksport=SOC_MIN+k_{—}sport*(SOC_MAX−SOC_MIN).

This means nothing other than that the value of the nominal state of charge soc_ksport of the energy accumulator 28 is calculated as a linear interpolation value from the sum of the minimal permitted state of charge SOC_MIN of the energy accumulator 28 plus the sportiness characteristic factor k_sport determined, the latter having a value only between 0% and 100%. This procedure ensures that damage to the energy accumulator 28 is avoided by never discharging it too low or charging it too high.

Other calculation methods are also conceivable. In addition, the calculation of the optimum nominal state of charge soc_ksport can be made dependent not only on the sportiness characteristic factor k_sport, but also on the current driving speed to take into account the kinetic energy stored in the vehicle. The mass of the vehicle required for determination of its kinetic energy can be calculated by various known methods, for example, from a measured distance between the vehicle's body and the road.

Furthermore, if the vehicle's speeds are high, it can be assumed that the driver has a strong preference for dynamic driving. On the other hand, however, it makes sense to keep the charge in the energy accumulator 28 rather low since, because of the vehicle's high kinetic energy, if the vehicle is braked in the generator mode the energy accumulator 28 can be rapidly charged up again. Moreover at high vehicle speeds, the electric additional power (boosting) by the at least one electric machine EM1, EM2 and the related rotation speeds contribute only a little to the total power of the vehicle.

In the tables constituting FIGS. 8 and 9, for a total of nine operating modes of a hybrid driveline 1 or 2, those boundary conditions are listed under which the operating modes are recognized as such by the device 22 or 25 for the determination of the nominal state of charge soc_ksport and the operating mode.

Operating mode No. 1 is the so-termed boosting mode, namely that mode in which the drive-power of the combustion engine VM is boosted by motor operation of the at least one electric machine EM1, EM2. For this operating mode to be recognized in the device 22 or 25, the following condition must be fulfilled:
fahr_{—}soll_{—}p≧vm_max_{—}p&(soc_{—}ist<soc_{—}ksport).

This means that in relation to its drive-power, the combustion engine VM is boosted by at least one electric machine EM1, EM2 when the drive-power fahr_soll_p desired by the driver is greater than or equal to the maximum drive-power vm_max_p that can be provided by the combustion engine VM and, at the same time, the actual state of charge soc_ist is lower than the nominal state of charge soc_ksport determined by the current sportiness characteristic factor k_sport.

Operating mode No. 2 is the so-termed recuperation mode, in which the electrical energy accumulator 28 is charged by generator operation of the at least one electric machine EM1, EM2, the at least one electric machine EM1, EM2 being driven via the transmission 7 by the vehicle's drive wheels in a non-propulsive thrust-operation phase while no fuel is supplied to the combustion engine VM. For the operating mode to be recognized in the device 22 or 25 and established as the current operating mode of the vehicle, the following condition must be fulfilled:
fahr_{—}soll_{—}p≦vm_min_{—}p&(soc_{—}ist>soc_{—}ksport).

This means that the drive-power fahr_soll_p desired by the driver is less than or equal to the minimum drive-power vm_min_p that can be provided by the combustion engine VM, and at the same time the actual state of charge soc_ist of the electrical energy accumulator 28 is higher than the nominal state of charge soc_ksport determined by the current sportiness characteristic factor k_sport.

To establish operating mode No. 3 denoted as “fuel charging”, in which the electrical energy accumulator 28 is electrically charged by generator operation of the at least one electric machine EM1, EM2 assisted by the combustion engine VM with the use of fuel, the following condition must be fulfilled:
(vm_min_{—}p<fahr_{—}soll_{—}p<vm_max_{—}p)&(soc_{—}ist<soc_{—}ksport).

This condition means that the drive-power fahr_soll_p desired by the driver is higher than the minimum drive-power vm_min_p available from the combustion engine VM and lower than the maximum drive-power vm_max_p that can be produced by the drive engine VM (so the drive-power fahr_soll_p desired can be provided without problems by the combustion engine) while, at the same time, the actual state of charge soc_ist of the electrical energy accumulator 28 is lower than the nominal state of charge soc_ksport determined by the current sportiness characteristic factor k_sport.

Operating mode No. 4 is the “cap-reserve reduction” mode, namely, that mode in which electrical energy from the at least one energy accumulator 28 is drawn off for motor operation of the at least one electric machine EM1, EM2. Such a discharging process takes place, for example, during purely electric-motor operation of the hybrid vehicle. If the combustion engine VM is coupled the drive torque from the combustion engine is correspondingly reduced, so that the sum of the drive torques remains the same. For this operating mode to be recognized by the device 22 or 25 and established as the current operating mode of the vehicle, the following condition must be fulfilled:
(vm_min_{—}p<fahr_{—}soll_{—}p<vm_max_{—}p)&(soc_{—}ist>soc_{—}ksport).

This condition means that the drive-power fahr_soll_p desired by the driver is higher than the minimum drive-power vm_min_p available from the combustion engine VM and lower than the maximum drive-power vm_max_p that can be produced by the drive engine VM (so the drive-power fahr_soll_p desired can be provided without problems by the combustion engine) while, at the same time, the actual state of charge soc_ist of the electrical energy accumulator 28 is higher than the nominal state of charge soc_ksport determined by the current sportiness characteristic factor k_sport. Accordingly, in this operating mode electrical energy can be drawn from the energy accumulator 28 without falling below the preferred nominal state of charge soc_ksport. Such an operating mode can, for example, also be used in such a manner that the combustion engine is operated at a very favourable operating point and the power difference, relative to the drive-power desired by the driver, is produced by one of the at least one electric machine(s).

Operating mode No. 5 concerns the “recuperation+fuel charging” mode, namely that mode in which the electrical energy accumulator 28 is charged by generator operation of the at least one electric machine, this at least one electric machine being driven both by the vehicle's drive wheels via the transmission 7 and by the combustion engine VM which is supplied with fuel. For this operating mode to be recognized in the device 22 or 25 and established as the current operating mode of the vehicle, the following condition must be fulfilled:
(vm_min_{—}p≧fahr_{—}soll_{—}p)&(soc_{—}ist<soc_{—}ksport).

This condition means that the drive-power fahr_soll_p desired by the driver is lower than or equal to the minimum drive-power vm_min_p available from the combustion engine VM while, at the same time, the actual state of charge soc_ist of the electrical energy accumulator 28 is lower than the nominal state of charge soc_ksport determined by the current sportiness characteristic factor k_sport.

Operating mode No. 6 concerns the “boosting+cap-reserve reduction” mode, namely, one in which the electrical energy accumulator 28 is discharged due to motor operation of the at least one electric machine EM1, EM2. During this the combustion engine VM and the at least one electric machine EM1, EM2 act at the same time and, therefore, in relation to the total drive-power, additively upon the input shaft 6 of the transmission 7. For this operating mode to be recognized in the device 22 or 25 and established as the current operating mode of the vehicle, the following condition must be fulfilled:
(fahr_{—}soll_{—}p≧vm_max_{—}p)&(soc_{—}ist>soc_{—}ksport).

This condition means that the drive-power fahr_soll_p desired by the driver is higher than or equal to the maximum drive-power vm_max_p available from the combustion engine VM (so the combustion engine is operating as a motor) while, at the same time, the actual state of charge soc_ist of the electrical energy accumulator 28 is higher than the nominal state of charge soc_ksport determined by the current sportiness characteristic factor k_sport.

To establish operating mode No. 7, denoted as “cap-reserve reduction or fuel charging”, the electrical energy accumulator 28, depending on its state of charge, can either be charged by generator operation of the at least one electric machine with assistance from the operation of the combustion engine using fuel or can be operated as a motor with depletion of the energy reserve. During this, the operation of the combustion engine VM can also be used directly to drive the vehicle. For this operating mode to be recognized by the device 22 or 25 and established as the current operating mode of the vehicle, the following condition must be fulfilled:
vm_min_{—}p≦fahr_{—}soll_{—}p≦vm_max_{—}p.

This condition means that the drive-power fahr_soll_p desired by the driver is between the minimum drive-power vm_min_p and the maximum drive-power vm_max_p available from the combustion engine VM, and also the indicated limits can be reached. Operating mode No. 7 includes operating modes No. 3 (fuel charging) and No. 4 (cap-reserve reduction) described earlier and can be determined in another variant embodiment of the device 22 or 25.

Like operating mode No. 5, so too operating mode No. 8 concerns the “recuperation+fuel charging” mode, namely, that mode in which the electrical energy accumulator 28 is charged by generator operation of the at least one electric machine EM1, EM2. During this, the combustion engine VM can act to drive the at least one electric machine. In addition, the at least one electric machine is driven by the vehicle's wheels via the input shaft 6 of the transmission 7. For this operating mode to be recognized in the device 22 or 25 and established as the current operating mode of the vehicle, in contrast to operating mode No. 5 only the following condition need be fulfilled:
vm_min_p>fahr_soll_p.

This condition means that the drive-power fahr_soll_p desired by the driver need only be lower than the minimum drive-power vm_min_p available from the combustion engine VM (so the combustion engine is operating as a motor and can also drive the at least one electric machine). As in the case of operating mode No. 7, operating mode No. 8 is a variant embodiment which includes modes 2 and 3.

Finally, like operating mode No. 6, so too operating mode No. 9 concerns the “boosting+cap-reserve reduction” mode, namely, that in which the electrical energy accumulator 28 is discharged by operating the at least one electric machine EM1, EM2 as a motor. During this, the combustion engine VM and the at least one electric machine EM1, EM2 operate at the same time and, therefore, in relation to the total drive-power, additively upon the input shaft 6 of the transmission 7. For this operating mode to be recognized in the device 22 or 25 and established as the current operating mode of the vehicle in contrast to operating mode No. 6, only the following condition need be fulfilled:
fahr_soll_{—}p>vm_max_{—}p.

This condition means that the drive-power fahr_Soll_p desired by the driver need only be higher than the maximum drive-power vm_max_p available from the combustion engine VM. Accordingly, during this the combustion engine VM is operating as a motor, but the total drive-power of the vehicle has to be increased by electric-motor operation of the at least one electric machine EM1, EM2. As in the case of operating modes No. 7 and No. 8, operating mode No. 9 is a variant embodiment which includes modes 1 and 4.

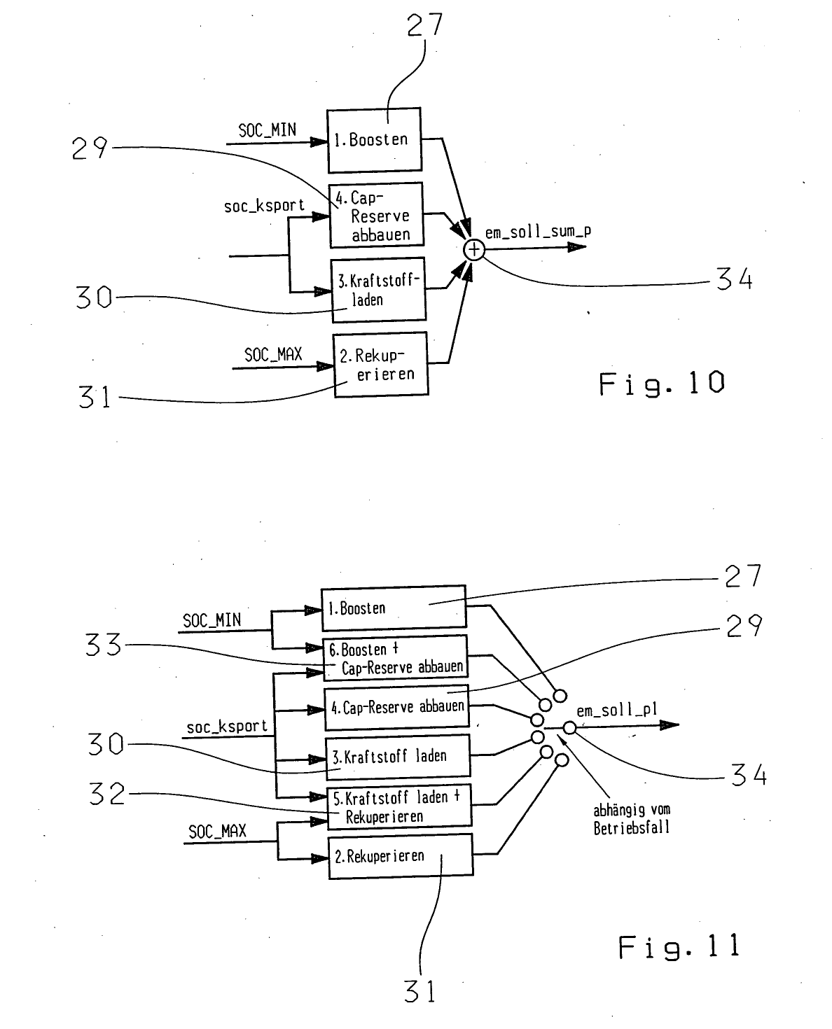

Coming back to FIG. 5, with the help of the determination device, according to the invention, after the optimum state of charge soc_ksport and the current operating mode have been determined, among other things as a function of the manner of operation (dynamic or economical) at the time, the nominal drive-power of the at least one electric machine EM1, EM2, is determined. An electric nominal total power em_soll_sum_p of the at least one electric machine EM1, EM2 (as a generator or electric motor) is determined, for example, as represented in FIG. 10. In this, as described earlier, the driver's wishes, in relation to the vehicle's drive-power and to the manner in which it is driven (dynamic or economical), are taken into account. In addition, the maximum and minimum power of the combustion engine and the current state of charge of the energy accumulator 28 are boundary conditions to be taken into account, upon which the motor or generator power of the at least one electric machine to be determined depends.

Thus, depending on a current operating mode 27=boosting, 29=cap-reserve reduction, 30=fuel charging or 31=recuperation determined and, taking into account, the minimum state of charge SOC_MIN, the maximum state of charge SOC_MAX and the currently determined optimum nominal state of charge of the energy accumulator 28, the above-mentioned electrical nominal total power em_soll_sum_p is determined for the two or for the only one electric machine EM1, EM2 and passed on to an output 34 of the device 23 for determining the electrically possible nominal drive-power. In the variant embodiment represented in FIG. 5, the nominal total power em_soll_sum_p is indexed em_soll_sum p1.

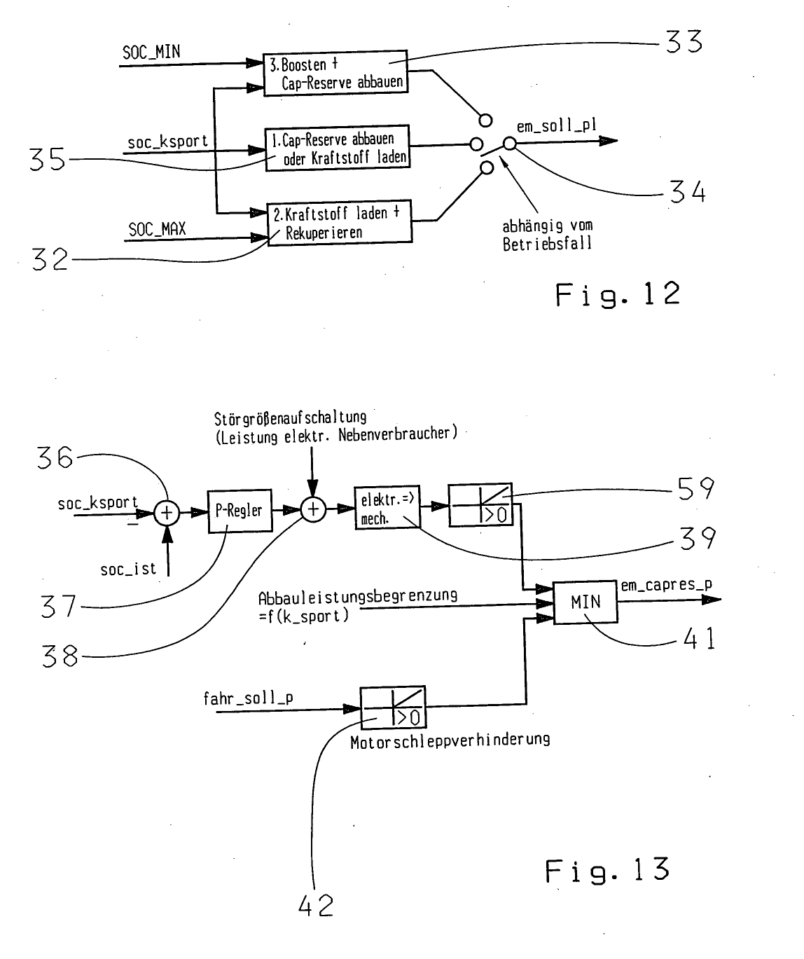

As made clear by FIG. 11 and FIG. 12, between the operating modes 27 (boosting), 29 (cap-reserve reduction), 30 (fuel charging) and 31 (recuperation) there can also be manners of operation which combine more than one of the operating modes. These include the modes already described above, namely, 32 (fuel charging+recuperation), 33 (boosting+cap-reserve reduction) and 35 (cap-reserve reduction or fuel charging). The determination device according to the invention and the associated method em_soll_sum_p1 are designed such that the electric machine EM1, EM2 calculated for the respective operating mode is sent to the output 34 of the device 23, and from there to the device 24 for establishing the drive-power distribution.

Below, for the examples of six operating modes represented in FIG. 11, it will be explained in greater detail with reference to FIGS. 13 to 18 how the values for the respective electrical nominal power of the at least one electric machine EM1, EM2 are determined.

As shown in FIG. 13, according to block 29 (cap-reserve reduction), in that operating mode and starting from the difference, formed by a difference calculator 36, between the nominal state of charge soc_ksport and the actual state of charge soc_ist of the energy accumulator 28, a desired electrical discharge power is first determined by a regulator 37. To this discharge power can also be added the electric power of any other electric auxiliary consumers in the motor vehicle that are currently active, in the sense of a superimposed interfering magnitude 38. With the help of the efficiency of the electric machine concerned, the electric power of the machine is then converted in a calculation stage 39 into its mechanical power. Clearly, in doing this, by virtue of a filter 42 only the positive fraction of the mechanical power of the electric machine is taken into account since only that fraction acts with motor effect.

Thereafter in the comparator module 41, a lowest-value selection takes place between the value of this mechanical power, a value known as the discharge power limit for limiting the electrical discharge power at the energy accumulator 28, and a value known as the engine drag prevention from a device 42 for determining an engine drag prevention value. The drive-power fahr_soll_p desired by the driver can be sent to the device 42.

The result of this comparison in the comparator module 41 is then the electrically, possible nominal power value em_capres_p for the at least one electric machine EM1 or EM2 concerned, by which electrical energy is drawn from the energy accumulator 28 during power boosting of the combustion engine VM by electric-motor operation.

The purpose of discharge power limitation is that when the sportiness characteristic factor k_sport is low, the electric discharge power at the electrical energy accumulator 28 is reduced, for example, for acoustic reasons. The purpose of the device 42 for determining an engine drag prevention value is to avoid drag operation of the combustion engine VM with use of electrical energy, at all times. For this, when the nominal drive-power is negative (i.e., in thrust operation) and the stage of charge of the accumulator 28 is too high, the output of the above-mentioned lowest-value selection at the comparator module 41 is kept at zero.

FIG. 13 makes the special feature of the present invention clear, namely, that the nominal power specification for the at least one electric machine EM1, EM2 depends, for each individual operating mode of the hybrid drive, on a previously determined nominal state of charge soc_ksport, which for its part is determined by the driving style (dynamic or economical) of the driver.

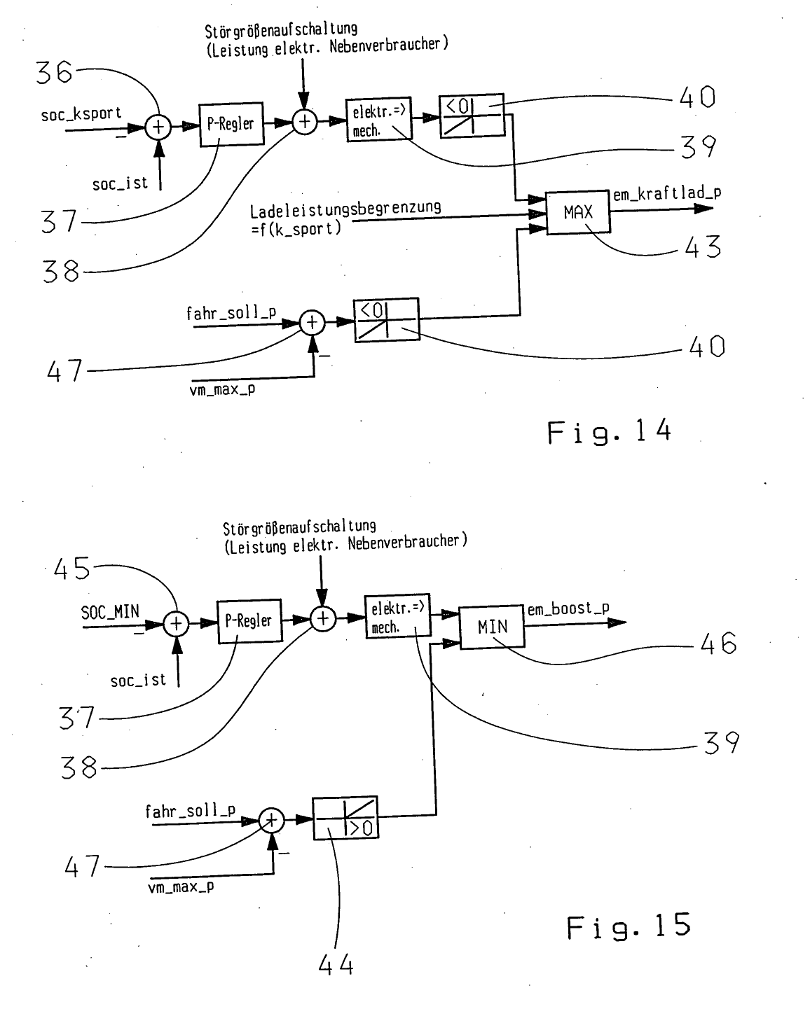

As illustrated in FIG. 14, according to the operating mode block 30 (fuel charging), in that mode and starting from the difference computed in the difference calculator 36 between the nominal state of charge soc_ksport and the actual state of charge soc_ist of the energy accumulator 28, a desired electrical charging power is first determined by the regulator 37. To this charging power can also be added the electric power of any other auxiliary electric consumers in the motor vehicle that are currently active, in the sense of a superimposed interfering magnitude 38. With the help of the efficiency of the electric machine concerned, its electric power is then converted in a calculation stage 39 into a mechanical power. Clearly, in doing this, by virtue of the filter 40 only the negative fraction of the mechanical power of the electric machine is taken into account, since only that fraction acts with generator effect.

Thereafter in a comparator module 43, a highest-value selection takes place between this mechanical power, a value known as the charge power limit for limiting the electric charging power at the energy accumulator 28, and a value from a device 47 for determining the power reserve of the combustion engine VM. To this device 47 can be sent the drive-power fahr_soll_p desired by the driver and the value of the maximum power vm_max_p of the combustion engine VM. The power reserve of the combustion engine is obtained from the negative difference, recognized in a filter device 40, between the value of the driver's desired nominal power fahr_soll_p and the maximum possible power vm_max_p of the combustion engine VM at its current engine speed.

The result of this comparison in the comparator module 43 is then the electrically, possible nominal charging power value em_kraftlad_p for the at least one electric machine EM1 or EM2 concerned with which, driven by the combustion engine VM in generator operation, it charges electrical energy into the accumulator 28.

The charge power limit can serve, when the sportiness characteristic factor k_sport is low, to reduce the electric charging power at the accumulator 28, for example for acoustical reasons or to avoid harmfully high charging currents.

FIG. 14 also makes the special feature of this invention clear according to which the nominal charging power specification em_kraftlad_p depends on a previously determined nominal state of charge soc_ksport, which for its part is determined by the driving style (dynamic or economical) of the driver.

To determine the drive-power em_boost_p of the at least one electric machine EM1 and/or EM2, according to the operating mode block 27 (boosting) of FIG. 15, in this mode a difference calculator 45 first computes the difference between the minimum permissible state of charge SOC_MIN and the actual state of charge soc_ist of the energy accumulator 28. Then, with the help of the regulator 37, a desired boost power of the at least one electric machine EM1, EM2 is determined. To this boost power can also be added the electric power of any other auxiliary electric consumers in the motor vehicle that are currently active, in the sense of a superimposed interfering magnitude 38. Knowing the efficiency of the electric machine concerned, the electric power of this electric machine is converted by a calculation stage 39 into its mechanical power. In the event that the actual state of charge of the accumulator falls below the defined minimum SOC_MIN, the operating mode block 27 counteracts this, in that the accumulator is charged by generator operation of the at least one electric machine.

Thereafter in a comparator module 46, a lowest-value selection takes place between the mechanical power and a value from a difference calculator 47; the job of the latter being to determine the power reserve of the combustion engine VM. To this difference calculator 47 are sent the value of the drive-power fahr_soll_p desired by the driver and the maximum power value vm_max_p of the combustion engine VM at its current engine speed. The combustion engine power reserve is obtained as the positive difference, recognized in the filter device 44 for determining the power reserve of the combustion engine, between the value of the nominal power fahr_soll_p desired by the driver and the maximum possible power vm_max_p of the combustion engine VM at its current engine speed.

The result of the comparison in the comparator module 46 is then the nominal power value em_boost_p for the at least one electric machine EM1 or EM2 concerned with which, during combined combustion engine and electric motor operation of the vehicle, the at least one electric machine EM1 and/or EM2 contributes sufficient drive-power to enable the driver's nominal power specification fahr_soll_p to be reached despite the fact that all the power reserves (vm_max_p) of the combustion engine VM have been fully used.

FIG. 15 too makes the special feature of this invention clear according to which the nominal power specification em_boost p for the at least one electric machine EM1 and/or EM2 depends on the previously determined minimum state of charge SOC_MIN of the energy accumulator 28.

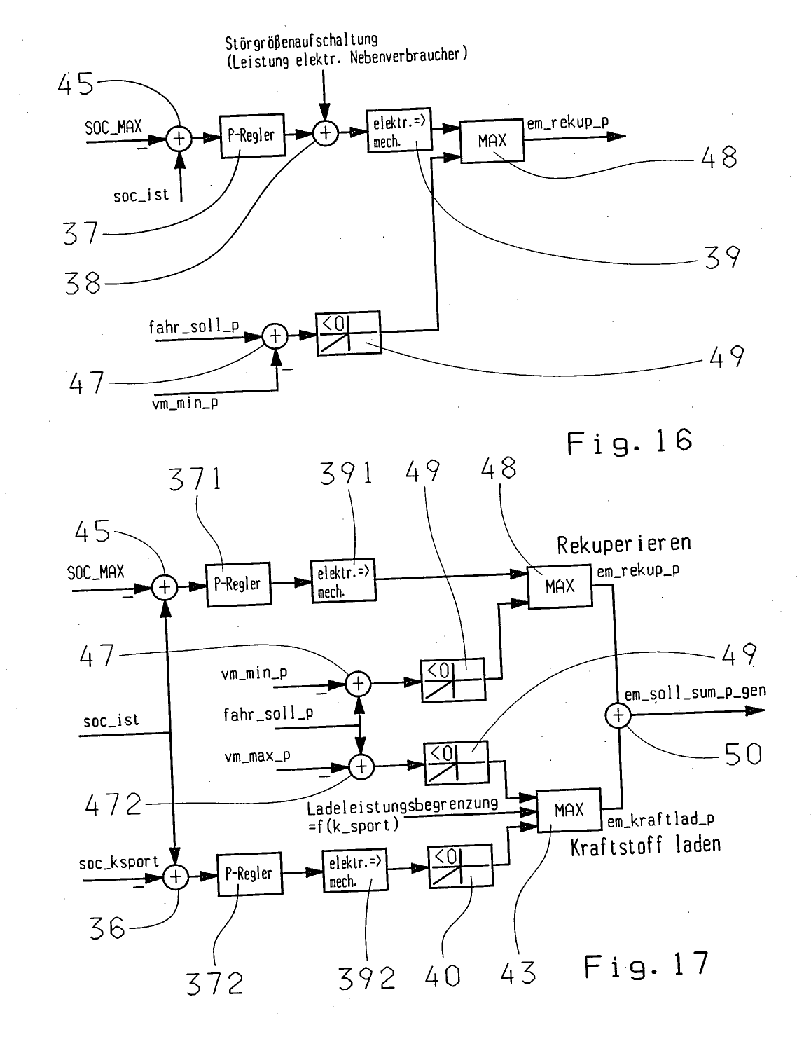

As shown in FIG. 16, according to operating mode block 31, in the recuperation mode and starting from the difference, computed in the difference calculator 45, between the maximum permissible nominal state of charge SOC_MAX and the actual state of charge soc_ist of the energy accumulator 28, the regulator 37 first determines a desired electrical charging power during the recuperation phase. To this charging power can also be added the electric power of any other auxiliary electric consumers in the motor vehicle that are currently active, in the sense of a superimposed interfering magnitude 38. Helped by knowledge of the efficiency of the electric machine concerned, the electric power of the electric machine EM1 or EM2 is then converted by a calculation stage 39 to its mechanical power. In the event that the accumulator's actual state of charge increases above the defined maximum SOC_MAX, this is counteracted by operating mode 31 (recuperation) in that the energy accumulator 28 is discharged by operating the at least one electric machine as a motor.

Thereafter in a comparator module 48, a highest-value selection takes place between the mechanical power just determined and the value from a device 49 for determining the power reserve of the combustion engine VM in thrust operation. To this device 49 can be sent the drive-power fahr_soll_p desired by the driver and the value vm_min_p of the minimum power of the combustion engine VM at its current engine speed. The combustion engine power reserve is then obtained as the negative difference, recognized in the device 49, between the value of the driver's desired nominal power fahr_soll_p and the minimum possible power vm_min_p of the combustion engine VM at its current engine speed.

The result of this comparison by the comparator module 48 is then the nominal power value em_rekup_p for the at least one electric machine EM1 and/or EM2 with which electrical energy is charged into the energy accumulator 28 during operation in the generator mode, which has a braking effect on the hybrid vehicle.

Here too, charging power limitation can serve, when the sportiness characteristic factor k_sport is low, to reduce the electric charging power at the electrical energy accumulator 28, for example, for acoustical reasons.

FIG. 16 too makes the special feature of the present invention clear according to which the nominal charging power specification em_rekup_p depends on a previously determined maximum state of charge SOC_MAX of the energy accumulator 28.

FIG. 17 shows the mixed-operation situation No. 5 (recuperation and fuel charging) according to block 32 in FIG. 11. To determine the optimum nominal power during this operating mode for the at least one electric machine EM1 and/or EM2, the maximum charge capacity SOC_MAX and the actual state of charge soc_ist are sent to a difference calculator 45, and the difference between these two values is computed. Then from this difference value, a regulator 371 calculates the desired electrical charging power for the at least one electric machine EM1, EM2. Thereafter, with the help of the efficiency of the electric machine concerned, the calculated electric power is converted in a calculation stage 391 to the mechanical power of the machine. The output value from the calculation stage 391 is then sent to a comparator module 48, whose function will be described later.

In parallel, the difference between the nominal soc_ksport and actual soc_ist states of charge of the electrical energy accumulator 28 is computed in a difference calculator 36. Then from this difference value, a regulator 372 calculates the electric charging power for the at least one electric machine EM1, EM2 desired from this standpoint. Thereafter with the help of the electric machine's efficiency, the calculated electric power is converted in a calculation stage 392 to the mechanical power of the machine. From this mechanical power value, the filter 40 then takes into account only the negative fraction of the electric machine's mechanical power, since only that fraction is active in the generator mode, and passes it on to a comparator module 43.

Also sent to the comparator module 43 is the charge power limit value for limiting the charging power of the at least one electric machine. The charging power limitation can serve, when the sportiness characteristic factor k_sport is low, to reduce the electrical charging power at the energy accumulator 28, for example, for acoustical reasons.

Also in parallel with the above, the value for the current maximum or minimum drive-power vm_max_p or vm_min_p of the combustion engine VM and the driver's currently desired drive-power fahr_soll_p are passed to a difference calculator 47 or 472. The result of this difference computation is then sent to two filter devices 49 for the determination, in each case, of a value of the power reserve of the combustion engine VM, the device 49 passing on to the comparator module 48 only values with a negative sign.

The two comparator modules 43 and 48 both work as highest-value reckoners, so the output magnitude from the comparator module 43 is the nominal power em_kraftlad_p for the “fuel charging” fraction of the operating situation (i.e. the combustion engine drives at least one of the electric machines as a generator with use of fuel) and the output magnitude from the other comparator module 48 forms the nominal power em_rekup_p for the “recuperation” fraction of the operating situation.

These two nominal powers em_kraftlad_p and em_rekup_p are then sent to a summation module 50, so that their result constitutes the nominal charging power value em_soll_sum_p_gen of the at least one electric machine EM1 and/or EM2 with which the latter, in generator operation driven by the combustion engine VM and via the vehicle's drive wheels, charge(s) the electrical energy accumulator 28.

FIG. 17 as well makes the special feature of this invention clear according to which the sum of the nominal charging power specification em_kraftlad_p and the nominal charging power specification em_rekup_p depends on the previously determined nominal state of charge soc_ksport which for its part is determined by the driving style (dynamic or economical) of the driver.

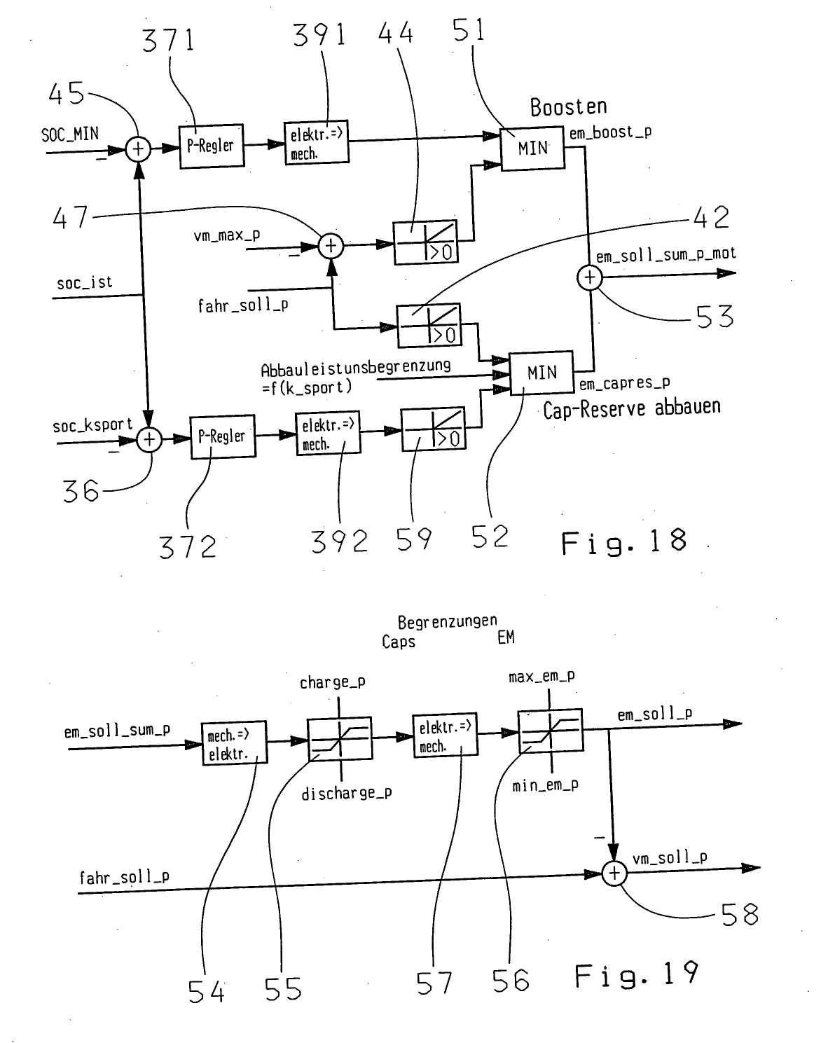

Finally, as the last example of operating-status-dependent determination of the nominal power of the at least one electric machine EM1, EM2, FIG. 18 shows the structure of the device and sequence of the process for determining the nominal power specification em_soll_sum_p_mot for the mixed operating mode No. 6 (block 33 in FIG. 11) in which, in relation to the vehicle's total drive-power, the combustion engine VM is boosted by operation of the at least one electric machine EM1, EM2 for which the electrical energy accumulator 28 delivers electrical energy.

To establish the optimum nominal power of the at least one electric machine EM1 and/or EM2 in this operating mode, the minimum permissible charge capacity SOC_MIN and the current state of charge soc_ist of the electrical energy accumulator 28 are sent to the difference calculator 45, and the difference between these two values is computed. Then, from this difference value, a regulator 371 calculates the desired electric power for the at least one electric machine EM1, EM2. Thereafter with the help of the efficiency of the electric machine concerned, the calculated electric power is converted so the machine's mechanical power is in a calculation stage 391. The output value of the calculation stage 391 is then sent to a comparator module 51, whose function is explained further below.

In parallel, the difference between the values of the nominal state of charge soc_ksport and the actual state of charge soc_ist of the electrical energy accumulator 28 is computed in the difference calculator 36. Then, from this difference value the regulator 372 calculates the electric power of the at least one electric machine EM1, EM2 desired from that standpoint. Thereafter with the help of the efficiency of the electric machine concerned, the calculated electric power is converted to the machine's mechanical power in a calculation stage 392. From this value for the mechanical power, a filter device 59 takes into account only the positive fraction, since only that fraction acts with motor effect and passes it to a comparator module 52.

To this comparator module 52 is also sent the value of the discharge power limit for limiting the discharging power of the energy accumulator 28. The discharge power limitation serves, for example, to reduce the electric charging power at the electrical energy accumulator 28 when the sportiness characteristic factor k_sport is low, for example, for acoustic reasons or to protect the energy accumulator 28 in relation to its operating load.

Also in parallel with the above, the value vm_max_p for the maximum drive-power of the combustion engine VM and the current drive-power fahr_soll_p desired by the driver are sent to the difference calculator 47. The resulting difference value is then sent to the two filter devices 44 and 42 for the determination of a value of the power reserve of the combustion engine VM, of which the device 44, as a filter, passes only values with a positive sign on to the comparator module 51, as also the filter device 42 passes only values with a positive sign on to the other comparator module 52.

The two comparator modules 51 and 52 both work as lowest-value calculators, so that the output magnitude from the comparator module 51 is the nominal power em_boost_p for the “boosting” fraction of the operating situation (i.e., when at least one of the electric machines operates as a motor by drawing electrical energy from the energy accumulator), and the output magnitude from the other comparator module 52 forms the nominal power em_capres_p for the “cap-reserve” fraction of the operating situation.

These two nominal powers em_boost_p and em_capres_p are then sent to a summation module 53, so that their result constitutes the nominal total power value em_soll_sum_p_mot of the at least one electric machine EM1, EM2 with which the latter, operating as a motor, supports the combustion engine VM in producing the drive-power fahr_soll_p desired by the driver.

Finally, FIG. 18 also makes the special feature of the present invention clear according to which the sum of the nominal power specifications em_boost_p and em_capres_p depends on the previously determined nominal state of charge soc_ksport which is, in turn, determined by the driving style (dynamic or economical)_of the driver.

Lastly, FIG. 19 shows how the nominal total power value em_soll_sum_p determined as described above is used in the device 24 to establish the drive-power distribution between the combustion engine VM and the at least one electric machine EM1, EM2. Accordingly, the nominal power value em_soll_sum_p, determined as described in relation to the operating mode and as a function of the desired drive-power and sportiness characteristic, is transformed in a calculation stage 54 from a mechanical magnitude into an electrical magnitude.

Then, a check module 55 checks whether the electric nominal value specification for the at least one electric machine can be realized under the boundary conditions of the charge or discharge power limits charge_p or discharge_p of the electrical energy accumulator 28. In that respect only such charging and discharging power values are permitted, which are technically appropriate and do not damage the electrical energy accumulator. Then, in a calculation stage 57, the electric nominal power specification for the at least one electric machine is back-converted into a mechanical power value.

In the next step, the output signal from the module 57 is sent to a check module 56 which checks whether the nominal power calculated for the at least one electric machine is, in fact, located within the range of its power limits. Thus, this check module 56 only admits nominal drive-power specifications which lie between the limits consisting of the maximum power max_em_p and the minimum power min_em_p of the at least one electric machine.

Thereafter, the nominal power specification so determined for the at least one electric machine is, on the one hand, used for the control of the at least one electric machine and, on the other hand, sent to a difference calculator device 58 in which this nominal power specification em_soll_p is subtracted from the current drive-power fahr_soll_p desired by the driver. As the output magnitude of the difference calculator device 58, a nominal power specification for the combustion engine VM is produced and sent, as necessary, to an engine control unit or directly to the power control element of the combustion engine.

In conclusion, it should be conveyed that the device features of the devices 22, 23 and 24 mentioned in the first part of the description of the invention, before the description of the Figures, also describe features of the method. These device structures can be realized in an electronic unit such as a computer, for example, by discrete electronic building blocks or by process steps in related computer programs. The present invention, therefore, also concerns process characteristics which are functionally equivalent to those mentioned above. Only to avoid repetitiousness of its content has the description been presented in a form not completely formulated in relation to the method.

### REFERENCE NUMERALS

1 driveline with one electric machine
2 driveline with two electric machines
3 crankshaft
4 rotation fluctuation damper
5 output of the rotation fluctuation damper
6 transmission input shaft
7 automatic transmission
8 oil pump
9 drive shaft of the oil pump
10 control unit for the combustion engine
11 control unit for electric machine em1
12 control unit for electric machine em2
13 control unit for clutch k1
14 control unit for clutch k2
15 electricity supply system in the vehicle
16 line resistance
17 line resistance
18 differential
19 brake device
20 transmission control unit
21 brake control unit
22 device for determining the nominal state of charge of the energy accumulator and the operating mode of the vehicle
23 device for determining the electrically possible nominal drive-power
24 device for establishing the drive-power distribution
25 device for determining the nominal state of charge of the energy accumulator and the operating mode of the vehicle
26 calculation module for determining the nominal state of charge of the electrical energy accumulator
27 operating mode; boosting
28 energy accumulator, electric battery
29 operating mode; cap-reserve reduction
30 operating mode; fuel charging
31 operating mode; recuperation determined
32 operating mode; fuel charging+recuperation
33 operating mode; boosting+cap-reserve reduction
34 output
35 operating mode; cap-reserve reduction or fuel charging
36 difference calculator
37 regulator
38 superimposed interfering magnitude
39 calculation stage
40 filter device
41 comparator module
42 filter device
43 comparator module
44 filter device
45 difference calculator
46 comparator module
47 difference calculator
48 comparator module
49 filter device
50 summation module
51 comparator module
52 comparator module
53 summation module
54 calculation stage
55 check module
56 check module
57 calculation stage
58 difference calculator
59 filter device
371 regulator
372 regulator
391 calculation stage
392 calculation stage
   Operating Mode Current Operating Mode of the Vehicle
EM1 electric motor
EM2 electric motor
VM combustion engine
K1 clutch
K2 clutch
ΘVM moment of inertia of the combustion engine
ΘEM1 moment of inertia of electric machine 1
ΘEM2 moment of inertia of electric machine 2
ΘRad (Θwheel) moment of inertia of the vehicle's wheels
k_sport sportiness characteristic factor
soc_ksport nominal state of charge of the energy accumulator
soc_ist actual state of charge of the energy accumulator
SOC_MIN minimum state of charge of the energy accumulator
SOC_MAX maximum state of charge of the energy accumulator
fahr_soll_p nominal drive-power, drive-power desired by the driver
vm_min_p minimum drive-power of the combustion engine
vm_max_p maximum drive-power of the combustion engine
vm_soll_p nominal drive-power of the combustion engine
charge_p charging power at the energy accumulator
   (permissible limit)
discharge_p discharge power at the energy accumulator
   (permissible limit)
max_em_p maximum possible power of the at least one electric machine
min_em_p minimum possible power of the at least one electric machine
e_soll_p mechanical nominal drive-power of the at least one electric machine EM1, EM2
em_soll_p1 electrically possible nominal drive-power for the at least one electric machine (intermediate value)
em_soll_sum_p electrically possible nominal total power from individual operating modes for the at least one electric machine
em_soll_sum_p1 nominal total power
M_VM drive torque of the combustion engine
M_K2 drive torque on the clutch K2
M_EM2 drive torque of the electric machine EM2
M_GE drive torque on the transmission input shaft
em_kraftlad_p electrically, possible nominal power during charging of the energy accumulator by the combustion engine
em_boost_p electrically, possible nominal power during torque support of the combustion engine (boosting)
em_rekup_p electrically possible nominal charging power of the electric machine during thrust operation of the vehicle
em_capres_p electrical reserve power for electric motor operation

1-35. (canceled)

36. A device for determination of the drive-power distribution in a hybrid driveline (1, 2) of a vehicle, for example a land or water vehicle or aircraft, with a combustion engine (VM), at least one electric drive machine (EM1, EM2) and a transmission (7), with means to detect a drive-power (fahr_soll_p) desired by a driver, means to detect operating parameters of the combustion engine and at least one electric drive machine (VM, EM1, EM2), means to detect a state of charge of an electrical energy accumulator (28) and means for dividing the drive-power (fahr_soll_p) desired by the driver into nominal power specifications for the combustion engine and at least one electric drive machine (VM, EM1, EM2), a device (22) for determining a nominal state of charge (soc_ksport) of the energy accumulator (28) as a function of the driver's current dynamic or economical manner of driving, and
for determining a current mode of operation (operating mode) of the driveline as a function of the nominal state of charge (soc_ksport),
a device (23) for determining a electrically possible nominal drive-power (em_soll_p1) for the at least one electric machine (EM1, EM2) as a function of the nominal state of charge (soc_ksport) and the current mode of operation (operating mode) of the driveline, and
a device (24) for determining a nominal drive-power (vm_soll_p, em_soll_p) for the combustion engine (VM) and the at least one electric machine (EM1, EM2) as a function of the electrically possible nominal drive-power (em_soll_p1).

37. The device according to claim 36, wherein for determination of the nominal state of charge (soc_ksport) and the mode of operation (operating mode), the following magnitudes can be sent to the device (22) for determining those values: a sportiness characteristic factor (k_sport), an actual state of charge (soc_ist) of the energy accumulator (28), the drive-power (fahr_soll_p) desired by the driver, and a minimum (vm_min_p) and a maximum (vm_max_p) power of the combustion engine (VM) at a current engine speed.

38. The device according to claim 37, wherein a minimum (SOC_MIN) and maximum (SOC_MAX) states of charge of the electrical energy accumulator (28) can be sent to the device (22) for determining the nominal state of charge (soc_ksport) and the mode of operation (operating mode).

39. The device according to claim 36, wherein the following magnitudes can be sent to the device (23) for determining the electrically possible nominal power (em_soll_p1) for the determination of the same:
the current mode of operation (operation mode), an actual state of charge (soc_ist), the nominal state of charge (soc_ksport), a characteristic magnitude for limiting a charging power (charge power limit) of the electrical energy accumulator (28) as a function of the sportiness characteristic factor (k_sport), the values for the minimum and maximum states of charge (SOC_MIN, SOC_MAX) of the energy accumulator (28), and a minimum (vm_min_p) and maximum (vm_max_p) power of the combustion engine (VM) at its current engine speed.

40. The device according to claim 36, wherein the following magnitudes can be sent to the device (24) for determining the drive-power distribution, for the determination of the same:
the electrically possible nominal drive-power (em_soll_p1), the drive-power (fahr_soll_p) desired by the driver, a maximum discharge power (discharge_p) and a maximum charge power (charge_p) of the energy accumulator (28), and a minimum (min_em_p) and maximum (max_em_p) drive-power of the at least one electric machine (EM1, EM2).

41. The device according to claim 39, wherein for several operating modes running in parallel, the respective operating-mode-related, electrically possible nominal drive-power values can be summed at an output (34) of the device (23) to give an electrically possible nominal total drive-power value (em_soll_sum_p).

42. The device according to claim 39, wherein the device (23) for determining the current electrically possible nominal drive-power (em_soll_p1) comprises at least one difference calculator (36), in which a difference between the values of the actual state of charge (soc_ist) and the nominal state of charge (soc_ksport) of the electrical energy accumulator (28) can be computed.

43. The device according to claim 39, wherein the device (23) comprises at least one difference calculator (45) in which a difference between the actual state of charge (soc_ist) and one of the maximum (SOC_MAX) or minimum (SOC_MIN) states of charge of the electrical energy accumulator (28), according to the operating mode, can be computed.

44. The device according to claim 42, wherein the device (23) for determining a electrically possible nominal drive-power (em_soll_p1) comprises at least one regulator (37, 371, 372) by means of which, for the difference value obtained from the difference calculator (36, 45), a respective value for an electric drive-power of the at least one electric machine (EM1, EM2) can be determined.

45. The device according to claim 44, wherein electric power of other electric consumers in the motor vehicle (38) can be added to the value determined in the regulator (37, 371, 372) for an electric drive-power.

46. The device according to claim 36, wherein the device (23) for determining a electrically possible nominal drive-power (em_soll_p1) comprises at least one calculation stage (39, 391, 392) by means of which, from an output value from a regulator (37, 371, 372) and with help of the efficiency of the electric machine (EM1, EM2), a respective value of the electric power can be converted to the respective mechanical power of the at least one electric machine (EM1, EM2).

47. The device according to claim 36, wherein the device (23) for determining a electrically possible nominal drive-power (em_soll_p1) comprises at least one filter device (40) which passes on only negative values from a calculation stage (39).

48. The device according to claim 36, wherein the device (23) for determining a electrically possible nominal drive-power (em_soll_p1) comprises at least one filter device (59) which passes on only positive values from calculation stage (39, 392).

49. The device according to claim 36, wherein the device (23) for determining a electrically possible nominal drive-power (em_soll_p1) comprises at least one filter device (42) which passes on only positive values of the drive-power (fahr_soll_p) desired by the driver.

50. The device according to claim 36, wherein the device (23) for determining a electrically possible nominal drive-power (em_soll_p1) comprises at least one filter device (40), which passes on only negative values from a difference calculator (47) in which a difference between the drive-power (fahr_soll_p) desired by the driver and a maximum possible drive-power (vm_max_p) of the combustion engine (VM) at a current engine speed can be determined.

51. The device according to claim 36, wherein the device (23) for determining a electrically possible nominal drive-power (em_soll_p1) comprises a filter device (49), which passes on only negative values from a difference calculator (47) in which a difference between the drive-power (fahr_soll_p) desired by the driver and one of a maximum possible (vm_max_p) or minimum possible (vm_min_p) drive-power of the combustion engine (VM) at a current engine speed, depending on the operating mode, can be determined.

52. The device according to claim 36, wherein in the device (23) for determining a electrically possible nominal drive-power (em_soll_p1), an output value of a filter device (59), a value for discharge power limitation (discharge power limit) and an output value of a filter device (42) can be sent to a comparator module (41), and the comparator module (41) is configured as a lowest-value calculator for passing on a lowest of the values, which constitutes an electrically possible nominal value of an electric machine power (em_capres_p) for electric-motor drive.

53. The device according to claim 36, wherein in the device (23) for determining a electrically possible nominal drive-power (em_soll_p1) an output value of a filter device (40), a value for charge power limitation and an output value of a further filter device (49) can be sent to a comparator module (43), and the comparator module (43) is configured as a highest-value calculator for passing on a highest of the values, which constitutes an electrically possible nominal value of a charging power (em_kraftlad_p) for generator operation of the at least one electric machine (EM1, EM2) when the electric machine is driven by the combustion engine (VM).

54. The device according to claim 36, wherein in the device (23) for determining a electrically possible nominal drive-power (em_soll_p1) an output value of a calculation stage (39) and an output value of the filter device (44) can be sent to a comparator module (46), and the comparator module (46) is configured as a lowest-value calculator for passing on a lowest of the values, which constitutes an electrically possible nominal value (em_boost_p) for the electric machine power during electric-motor boosting of the drive-power of the combustion engine (VM).

55. The device according to claim 36, wherein in the device (23) for determining a electrically possible nominal drive-power (em_soll_p1), an output value of a calculation stage (39) and a value for an output value of a filter device (49) can be sent to a comparator module (48), and the comparator module (48) is configured as a highest-value calculator for passing on a highest of the values, which constitutes an electrically possible nominal value for a charging power (em_rekup_p) of the at least one electric machine during generator operation of this at least one electric machine with a braking effect on the hybrid vehicle.

56. The device according to claim 36, wherein in the device (23) for determining a electrically possible nominal drive-power (em_soll_p1), an output value of a calculation stage (391) and an output value of a first filter device (49) can be sent to a first comparator module (48), an output value of a second filter device (40), a charging power limitation value and the output value of the first filter device (49) can be sent to a second comparator module (43), and the output values of the first and second comparator modules (43 and 48) can be sent to a summation module (50), whose output value constitutes an electrically possible nominal total charging power (em_soll_sum_p_gen) for generator operation of the at least one electric machine (EM1, EM2) during recuperative operation and simultaneous generator operation driven by the combustion engine (VM).

57. The device according to claim 36, wherein in the device (23) for determining a electrically possible nominal drive-power (em_soll_p1), an output value of a calculation stage (391) and an output value of a first filter device (44) can be sent to a first comparator module (51), an output value of a second filter device (59), a value for discharge power limitation (discharge power limit) and an output value of a third filter device (42) can be sent to a second comparator module (52), and the output values of the first and second comparator modules (51 and 52) can be sent to a summation module (53), whose output value constitutes an electrically possible nominal total power (em_soll_sum_p_mot) for electric-motor operation of the at least one electric machine (EM1, EM2) for electric-motor boosting of the combustion engine (VM) using electrical energy from the energy accumulator (28).

58. The device according to claim 36, wherein in the device (24) for determining nominal drive-power (em_soll_sum_p) for one of a generator or motor operation of the at least one electric machine (EM1, EM2) can be sent to a first calculation stage (54) for transforming the mechanical power specification into an electrical power specification, an output value of the calculation stage (54) can be sent to a first check module (55) for charge and discharge power limitation of the energy accumulator (28), an output value of the said first check module (55) can be sent to a second calculation stage (57), in which the output value of the first check module (55), present as an electrical nominal drive-power, can be converted to a mechanical nominal drive-power for the at least one electric machine, the output magnitude of the calculation stage (57) can be sent to a second check module (56) which takes into account a minimum and maximum power limits (min_em_p, max_em_p) of the at least one electric machine (EM1, EM2), the nominal drive power (em_soll_p) can be sent to an actuator for controlling the at least one electric machine (EM1, EM2) and to a difference calculator (58), in which a difference between the nominal drive-power (fahr_soll_p) of the vehicle desired by the driver and the nominal drive-power (em_soll_p) can be computed, and an output value of the difference calculator (58) (vm_soll_p) can be sent to an actuator for controlling a power control element of the combustion engine (VM) or to a related engine control unit.

59. A method for determination of a drive-power distribution in a hybrid driveline (1, 2) of a motor vehicle, with a combustion engine (VM), at least one electric drive machine (EM1, EM2) and a transmission (7), the method further comprising the steps of:
detecting a value of the currently desired drive-power (fahr_soll_p) desired by a driver,
determining a minimum and maximum power (vm_min_p, vm_max_p) of the combustion engine at a current engine speed,
determining an actual state of charge (soc_ist) and minimum and maximum states of charge (SOC_MIN, SOC_MAX) of an energy accumulator (28), detecting a sportiness characteristic factor (k_sport) associated with the driver, determining a minimum and maximum charging power (charge_p, discharge_p) of the energy accumulator, and
determining a the minimum and maximum drive-power (em_min_p, em_max_p) of the at least one electric drive machine,
a nominal state of charge (soc_ksport) is calculated from the value of the currently desired drive-power (fahr_soll_p) and the sportiness characteristic factor (k_sport), the vehicle's current operating situation is determined as a function of the sportiness characteristic factor (k_sport), the minimum and maximum power (vm_min_p, vm_max_p) of the combustion engine, and the actual state of charge (soc_ist) of the energy accumulator (28), with help of the values for the sportiness characteristic factor (k_sport), the current operating situation, the actual state of charge (soc_ist) and the minimum and maximum states of charge (SOC_MIN, SOC_MAX) of the energy accumulator, a charge power limitation value (charge power limit) and a discharge power limitation value (discharge power limit) and the minimum and maximum power (vm_min_p, vm_max_p) of the combustion engine at its current speed, an electrically possible nominal drive-power value (em_soll_p1) for the at least one electric machine (EM1, EM2) is determined, and with help of the electrically possible nominal drive-power value (em_soll_p1) and the minimum and maximum charge power (charge_p, discharge_p) of the energy accumulator and with the current minimum and maximum drive-power (em_min_p, em_max_p) of the at least one electric machine, nominal drive-power values (em_soll_p, vm_soll_p) are produced for the at least one electric machine (EM1, EM2) and the combustion engine (VM).

60. The method according to claim 59, further comprising the step of determining the nominal state of charge (soc_ksport) by the equation:
soc_{—}ksport=SOC_MIN+k_{—}sport·(SOC_MAX−SOC_MIN),
according to which the nominal state of charge (soc_ksport) is calculated as a sum of the minimum permissible state of charge (SOC_MIN) of the energy accumulator (28) plus the current sportiness characteristic factor (k_sport), the latter assuming only values between the minimum and maximum permissible states of charge (SOC_MIN, SOC_MAX) of the energy accumulator (28).

61. The method according to claim 60, further comprising the step of additionally computing the nominal state of charge (soc_ksport) as a function of the current driving speed.

62. The method according to claim 59, further comprising the step of recognizing a “boosting” operating mode when the following condition is fulfilled:
fahr_{—}soll_{—}p≧vm_max_{—}p&(soc_{—}ist<soc_{—}ksport)
according to which, in relation to its drive-power, the combustion engine (VM) is boosted by the at least one electric machine (EM1, EM2) when the nominal drive-power (fahr_soll_p) desired by the driver is greater than or equal to the maximum drive-power (vm_max_p) that can be provided by the combustion engine at a current engine speed, and at the same time the actual state of charge (soc_ist) of the energy accumulator is lower than the nominal state of charge (soc_ksport) determined by the current sportiness characteristic factor (k_sport).

63. The method according to claim 59, further comprising the step of the recognizing a “recuperation” operating mode when the following condition is fulfilled:
fahr_{—}soll_{—}≦vm_min_{—}p&(soc_{—}ist>soc_{—}ksport),
in which the nominal drive-power (fahr_soll_p) is lower than or equal to the minimum drive-power (vm_min_p) that can be provided by the combustion engine (VM) at its current speed, and at the same time the actual state of charge (soc_ist) of the electrical energy accumulator (28) is higher than the nominal state of charge (soc_ksport) determined by the current sportiness characteristic factor (k_sport).

64. The method according to claim 59, further comprising the step of recognizing a “fuel charging” operating mode when the following condition is fulfilled:
(vm_min_{—}p≧fahr_{—}soll_{—}p<vm_max_{—}p)&(soc_{—}ist<soc_{—}ksport),
in which the nominal drive-power (fahr_soll_p) desired by the driver is lower than or equal to the minimum drive-power (v_min_p) that can be provided by the combustion engine (VM) at its current speed and also lower than the maximum drive-power (vm_max_p) that can be provided by the drive engine (VM) at its current speed, while at the same time the actual state of charge (soc_ist) of the electric energy accumulator (28) is lower than the nominal state of charge (soc_ksport) determined by the current sportiness characteristic factor (k_sport).

65. The method according to claim 59, further comprising the step of the recognizing a “cap-reserve reduction” operating mode when the following condition is fulfilled:
(vm_min_{—}p<fahr_{—}soll_{—}p<vm_max_{—}p)&(soc_{—}ist>soc_{—}ksport),
in which the nominal drive-power (fahr_soll_p) desired by the driver is higher than the minimum drive-power (vm_min_p) available from the combustion engine (VM) at its current speed and lower than the maximum drive-power (vm_max_p) that can be produced by the said drive engine (VM) at its current speed, while at the same time the actual state of charge (soc_ist) of the electrical energy accumulator (28) is higher than the nominal state of charge (soc_ksport) determined by the current sportiness characteristic factor (k_sport).

66. The method according to claim 59, further comprising the step of recognizing a “recuperation+fuel charging” operating mode when the following condition is fulfilled:
(vm_min_{—}p≧fahr_{—}soll_{—}p)&(soc_{—}ist<soc_{—}ksport),
in which the nominal drive-power (fahr_soll_p) desired by the driver is lower than or equal to the minimum drive-power (vm_min_p) available from the combustion engine (VM) at its current speed, while at the same time the actual state of charge (soc_ist) of the electrical energy accumulator (28) is lower than the nominal state of charge (soc_ksport) determined by the current sportiness factor (k_sport).

67. The method according to claim 59, further comprising the step of recognizing a “boosting+cap-reserve reduction” operating mode when the following condition is fulfilled:
(fahr_{—}soll_{—}p≧vm_max_{—}p)&(soc_{—}ist>soc_{—}ksport),
in which the nominal drive-power (fahr_soll_p) desired by the driver is higher than or equal to the maximum drive-power (vm_max_p) available from the combustion engine (VM) at its current speed, while at the same time the actual state of charge (soc_ist) of the electrical energy accumulator (28) is higher than the nominal state of charge (soc_ksport) determined by the current sportiness characteristic factor (k_sport).

68. The method according to claim 60, further comprising the step of recognizing a “cap-reserve reduction or fuel charging” operating mode when the following condition is fulfilled:
vm_min_{—}p≦fahr_{—}soll_{—}p≦vm_max_{—}p,
in which the nominal drive-power (fahr_soll_p) desired by the driver is between the minimum drive-power (vm_min_p) and the maximum drive-power (vm_max_p) available from the combustion engine (VM) at its current speed, and also the indicated limits can be reached.

69. The method according to claim 60, further comprising the step of recognizing a “recuperation+fuel charging” operating mode when the following condition is fulfilled:
vm_min_p>fahr_soll_p,
in which the nominal drive-power (fahr_soll_p) desired by the driver need only be lower than the minimum drive-power (vm_min_p) available from the combustion engine (VM) at its current engine speed.

70. The method according to claim 60, further comprising the step of recognizing a “boosting+cap-reserve reduction” operating mode when the following condition is fulfilled:
fahr_soll_p>vm_max_p,
in which the nominal drive-power (fahr_soll_p) desired by the driver need only be higher than the maximum drive-power (vm_max_p) available from the combustion engine (VM) at its current speed.
